(19) United States
(12) Patent Application Publication
(10) Pub. No.: US 2025/0185662 A1
(43) Pub. Date: Jun. 12, 2025

(54) COMPOSITION FOR ENHANCING PLANT GROWTH

(71) Applicant: CH BIOTECH R&D CO., LTD., NANTOU CITY (TW)

(72) Inventors: MENG-YING LI, NANTOU CITY (TW); CHO-CHUN HUANG, NANTOU CITY (TW); GUI-JUN LI, NANTOU CITY (TW); KAI XIA, NANTOU CITY (TW); CHEN-PANG WU, NANTOU CITY (TW)

(21) Appl. No.: 19/056,278

(22) Filed: Feb. 18, 2025

Related U.S. Application Data
(63) Continuation of application No. 17/470,167, filed on Sep. 9, 2021.
(60) Provisional application No. 63/209,581, filed on Jun. 11, 2021.

(51) Int. Cl. A01N 43/90; A01N 25/24; A01N 25/32; A01N 33/12; A01N 37/44; A01N 43/38; A01P 21/00

(52) U.S. Cl. CPC A01N 43/90; A01N 25/24; A01N 25/32; A01N 33/12; A01N 37/44; A01N 43/38; A01P 21/00

(57) ABSTRACT

The invention relates to a composition for enhancing plant growth. The composition includes auxin, cytokinin, choline chloride, and γ-aminobutyric acid (GABA). The invention also relates to a method for enhancing plant growth.

### CROSS-REFERENCE TO RELATED APPLICATIONS

This application claims priority as a continuation of U.S. patent application Ser. No. 17/470,167, filed on Sep. 9, 2021, which claims priority to U.S. Provisional Application 63/209,581, filed on Jun. 11, 2021, both of which are herein incorporated by reference in their entirety.

### BACKGROUND OF THE INVENTION

### 1. Field of the Invention

The present invention relates to a composition for enhancing plant growth. More particularly, the present invention relates to a composition including auxin, cytokinin, choline chloride, and y-aminobutyric acid (GABA).

### 2. Description of the Prior Art

As world population reaches approximately 7.9 billion, food security has been a serious issue in many countries. According to the Food and Agricultural Organization of the United Nations (FAO), global food production will need to increase by 70% if the population reaches 9.1 billion by 2050.

Although there has been plant growth regulator (PGR) products for improving plant growth and enhancing yield of crops, stresses such as drought and herbicide drift affect performance of those PGR products. To help crops grow well under various conditions, advanced formulations for releasing the development potential of crops are in demand.

### SUMMARY OF THE INVENTION

In one aspect, the present invention relates to a concentrate composition for enhancing plant growth. The concentrate composition comprises between about 0.8 g/L to about 80 g/L auxin, between about 0.18 g/L to about 18 g/L cytokinin, between about 0.5 g/L to about 50 g/L GABA, and between about 2.5 g/L to about 250 g/L choline chloride.

In another aspect, the present invention relates to a ready to use composition for enhancing plant growth. The ready to use composition comprises between about 0.8 mg/L to about 80 mg/L auxin, between about 0.18 mg/L to about 18 mg/L cytokinin, between about 0.5 mg/L to about 50 mg/L GABA, and between about 2.5 mg/L to about 250 mg/L choline chloride.

In another aspect, the present invention relates to a method for enhancing plant growth. The present invention is illustrated but not limited by the following embodiments and drawings.

### BRIEF DESCRIPTION OF THE DRAWINGS

FIG. 1A and FIG. 1B show shoot dry weight of corn plants in Example 1. The number above the bar of Glyphosate only group indicates the percentage decrease compared to Control group. The number above the bar of Test group 9 indicates the percentage increase compared to Glyphosate only group. (N=12) T1-T9: Test group 1 to Test group 9. * p<0.05; ** p<0.01.

FIG. 2A and FIG. 2B show shoot dry weight of soybean plants in Example 1. The number above the bar of Glyphosate only group indicates the percentage decrease compared to Control group. The number above the bar of Test group 9 indicates the percentage increase compared to Glyphosate only group. (N=12) T1-T9: Test group 1 to Test group 9. * p<0.05; ** p<0.01.

FIG. 3A and FIG. 3B show shoot dry weight of corn plants in Example 2. The number above the bar of Glyphosate only group indicates the percentage decrease compared to Control group. The numbers above the bars of Test groups indicate the percentage increase compared to Glyphosate only group. (N=12) T1-T9: Test group 1 to Test group 9. * p<0.05; ** p<0.01; *** p<0.001.

FIG. 4A and FIG. 4B show shoot dry weight of soybean plants in Example 2. The number above the bar of Glyphosate only group indicates the percentage decrease compared to Control group. The numbers above the bars of Test group 9 indicate the percentage increase compared to Glyphosate only group. (N=12) T1-T9: Test group 1 to Test group 9. * p<0.05; ** p<0.01.

FIG. 5A shows phenotype observation of corn plants 7 days after applied with (Glyphosate only group and Test groups 1-2) or without (Control group) glyphosate in Example 3. FIG. 5B shows phenotype observation of corn leaves 7 days after applied with (Glyphosate only group and Test groups 1-2) or without (Control group) Glyphosate in Example 3. The numbers indicate the order of leaf emergence, and the triangles indicate the 6th leaves.

FIG. 6 shows electrolyte leakage of corn plants 3 days after applied with (Glyphosate only group and Test groups 1-2) or without (Control group) glyphosate in Example 3. The number above the bar of Glyphosate only group indicates the percentage increase compared to Control group. The numbers above the bars of Test groups 1 and 2 indicate the percentage decrease compared to Glyphosate only group. (N=5) ** p<0.01.

FIG. 7 shows 2-thiobarbituric acid reactive substances (TBARS) levels of corn plants 3 days after applied with (Glyphosate only group and Test groups 1-2) or without (Control group) glyphosate in Example 3. The number above the bar of Glyphosate only group indicates the percentage increase compared to Control group. The numbers above the bars of Test groups 1 and 2 indicate the percentage decrease compared to Glyphosate only group. (N=5) * p<0.05 and *** p<0.001.

FIG. 8 shows activities of nitrate reductase (NR) of corn plants 3 days after applied with (Glyphosate only group and Test groups 1-2) or without (Control group) glyphosate in Example 3. The number above the bar of Glyphosate only group indicates the percentage decrease compared to Control group. The numbers above the bars of Test groups 1 and 2 indicate the percentage increase compared to Glyphosate only group. (N=5) * p<0.05.

FIG. 9 shows activities of glutamine synthetase (GS) of corn plants 3 days after applied with (Glyphosate only group and Test groups 1-2) or without (Control group) glyphosate in Example 3. The number above the bar of Glyphosate only group indicates the percentage decrease compared to Control group. The numbers above the bars of Test groups 1 and 2 indicate the percentage increase compared to Glyphosate only group. (N=5) * p<0.05 and *** p<0.001.

FIG. 10 shows activities of glutamate synthase (GOGAT) of corn plants 3 days after applied with (Glyphosate only group and Test groups 1-2) or without (Control group) glyphosate in Example 3. The number above the bar of Glyphosate only group indicates the percentage decrease compared to Control group. The numbers above the bars of Test groups 1 and 2 indicate the percentage increase compared to Glyphosate only group. (N=5) ** p<0.01.

FIG. 11 shows phenotype observation of soybean plants on 0, 1, 5, and 7 days after applied with (Glyphosate only group and Test groups 1-2) or without (Control group) Glyphosate in Example 3.

FIG. 12 shows phenotype observation of soybean leaves 7 days after applied with (Glyphosate only group and Test groups 1-2) or without (Control group) glyphosate in Example 3. The triangles indicate necrotic areas, and the arrows indicate leaf curling symptoms.

FIG. 13 shows electrolyte leakage of soybean plants 3 days after applied with (Glyphosate only group and Test groups 1-2) or without (Control group) glyphosate in Example 3. The number above the bar of Glyphosate only group indicates the percentage increase compared to Control group. The numbers above the bars of Test groups 1 and 2 indicate the percentage decrease compared to Glyphosate only group. (N=5) * p<0.05 and * p<0.01.

FIG. 14 shows TBARS levels of soybean plants 3 days after applied with (Glyphosate only group and Test groups 1-2) or without (Control group) glyphosate in Example 3. The number above the bar of Glyphosate only group indicates the percentage increase compared to Control group. The numbers above the bars of Test groups 1 and 2 indicate the percentage decrease compared to Glyphosate only group. (N=5) ** p<0.01 and *** p<0.001.

FIG. 15 shows activities of nitrate reductase (NR) of soybean plants 3 days after applied with (Glyphosate only group and Test groups 1-2) or without (Control group) glyphosate in Example 3. The number above the bar of Glyphosate only group indicates the percentage decrease compared to Control group. The numbers above the bars of Test groups 1 and 2 indicate the percentage increase compared to Glyphosate only group. (N=5) * p<0.05 and *** p<0.001.

FIG. 16 shows activities of glutamine synthetase (GS) of soybean plants 3 days after applied with (Glyphosate only group and Test groups 1-2) or without (Control group) Glyphosate in Example 3. The number above the bar of Glyphosate only group indicates the percentage decrease compared to Control group. The numbers above the bars of Test groups 1 and 2 indicate the percentage increase compared to Glyphosate only group. (N=5) *** p<0.001.

FIG. 17 shows activities of glutamate synthase (GOGAT) of soybean plants 3 days after applied with (Glyphosate only group and Test groups 1-2) or without (Control group) glyphosate in Example 3. The number above the bar of Glyphosate only group indicates the percentage decrease compared to Control group. The numbers above the bars of Test groups 1 and 2 indicate the percentage increase compared to Glyphosate only group. (N=5) ** p<0.01.

FIG. 18 shows shoot dry weight of corn plants in Example 4. The numbers above the bars of Test groups indicate the percentage increase compared to Control group. (N=12) T1-T5: Test group 1 to Test group 5. * p<0.05.

FIG. 19 shows shoot dry weight of soybean plants in Example 4. The numbers above the bars of Test groups indicate the percentage increase compared to Control group. (N=12) T1-T5: Test group 1 to Test group 5. * p<0.05; ** p<0.01.

FIG. 20A shows phenotype observation of corn leaves 7 days after applied with the reagents in Example 5. The triangles indicate the 7th leaves. FIG. 20B shows leaf area analysis of corn leaves 7 days after applied with the reagents in Example 5. The numbers above the bars of Test groups indicate the percentage increase compared to Control group. * p<0.05.

FIG. 21A shows shoot fresh weight of corn plants 7 days after applied with the reagents in Example 5. FIG. 21B shows shoot dry weight of corn plants 7 days after applied with the reagents in Example 5. The numbers above the bars of Test groups indicate the percentage increase compared to Control group. * p<0.05.

FIG. 22A shows phenotype observation of corn roots 7 days after applied with the reagents in Example 5. FIG. 22B shows root length analysis of corn leaves 7 days after applied with the reagents in Example 5. The numbers above the bars of Test groups indicate the percentage increase compared to Control group.

FIG. 23 shows root dry weight of corn plants 5 days after applied with the reagents in Example 5. The number above the bar of Test group 2 indicates the percentage increase compared to Control group. (N=12) * p<0.05; ** p<0.01.

FIG. 24 shows electron transport rates (ETR) of corn plants 4 days after applied with the reagents in Example 5.

FIG. 25 shows activities of nitrate reductase (NR) of corn plants 7 days after applied with the reagents in Example 5. The numbers above the bars of Test groups indicate the percentage increase compared to Control group. (N=3) * p<0.05; ** p<0.01.

FIG. 26 shows activities of glutamine synthetase (GS) of corn plants 7 days after applied with the reagents in Example 5. The numbers above the bars of Test groups indicate the percentage increase compared to Control group. (N=3) ** p<0.01; *** p<0.001.

FIG. 27 shows activities of glutamate synthase (GOGAT) of corn plants 7 days after applied with the reagents in Example 5. The numbers above the bars of Test groups indicate the percentage increase compared to Control group. (N=3) ** p<0.01; *** p<0.001.

FIG. 28 shows ZmG2 gene expression levels of corn plants 3 days after applied with the reagents in Example 5. (N=3) * p<0.05; ** p<0.01; *** p<0.001.

FIG. 29 shows ZmGLK1 gene expression levels of corn plants 3 days after applied with the reagents in Example 5. (N=3) * p<0.05.

FIG. 30 shows ZmDOF1 gene expression levels of corn plants 1 days after applied with the reagents in Example 5. (N=3) ** p<0.01.

FIG. 31 shows ZmPPdK gene expression levels of corn plants 3 days after applied with the reagents in Example 5. (N=3) * p<0.05; *** p<0.001.

FIG. 32 shows ZmPIP2;1 gene expression levels of corn plants 3 days after applied with the reagents in Example 5. (N=3) ** p<0.01; *** p<0.001.

FIG. 33A shows phenotype observation of soybean leaves 7 days after applied with the reagents in Example 5. The triangles indicate the 5th compound leaves. FIG. 33B shows leaf area analysis of soybean leaves 7 days after applied with the reagents in Example 5. The numbers above the bars of Test groups indicate the percentage increase compared to Control group. *** p<0.001.

FIG. 34A shows shoot fresh weight of soybean plants 7 days after applied with the reagents in Example 5. FIG. 34B shows shoot dry weight of soybean plants 7 days after applied with the reagents in Example 5. The numbers above the bars of Test groups indicate the percentage increase compared to Control group. * p<0.05; *** p<0.001.

FIG. 35A shows phenotype observation of soybean roots 7 days after applied with the reagents in Example 5. FIG. 35B shows root length analysis of soybean leaves 7 days after applied with the reagents in Example 5. The numbers above the bars of Test groups indicate the percentage increase compared to Control group. (N=6) * p<0.05.

FIG. 36 shows root dry weight of soybean plants 7 days after applied with the reagents in Example 5. The number above the bar of Test group 2 indicates the percentage increase compared to Control group. (N=12) * p<0.05.

FIG. 37 shows electron transport rates (ETR) of soybean plants 4 days after applied with the reagents in Example 5. The numbers above the bars of Test groups indicate the percentage increase compared to Control group. * p<0.05.

FIG. 38 shows activities of nitrate reductase (NR) of soybean plants 7 days after applied with the reagents in Example 5.

FIG. 39 shows activities of glutamine synthetase (GS) of soybean plants 7 days after applied with the reagents in Example 5. The numbers above the bars of Test groups indicate the percentage increase compared to Control group. *** p<0.001.

FIG. 40 shows activities of glutamate synthase (GOGAT) of soybean plants 7 days after applied with the reagents in Example 5. The numbers above the bars of Test groups indicate the percentage increase compared to Control group. (N=3) *** p<0.001.

FIG. 41 shows GmWRKY58 gene expression levels of soybean plants 3 days after applied with the reagents in Example 5. (N=3) *** p<0.001.

FIG. 42 shows GmWRKY76 gene expression levels of soybean plants 3 days after applied with the reagents in Example 5. (N=3) * p<0.05; ** p<0.01.

FIG. 43 shows gene expression levels of NAC domain transcriptional regulator protein of soybean plants 3 days after applied with the reagents in Example 5. (N=3) * p<0.05; ** p<0.01; *** p<0.001.

FIG. 44 shows GmCab3 gene expression levels of soybean plants 1 days after applied with the reagents in Example 5. (N=3) ** p<0.01; *** p<0.001.

FIG. 45 shows GmPIP1;6 gene expression levels of soybean plants 1 days after applied with the reagents in Example 5. (N=3) ** p<0.01.

FIG. 46 shows GmPIP2 gene expression levels of soybean plants 1 days after applied with the reagents in Example 5. (N=3) * p<0.05.

FIG. 47 shows expression levels of genes involved in lignin synthesis and cell elongation of soybean plants 6 days after applied with the reagents in Example 6. (N=3) * p<0.001.

FIG. 48 shows expression levels of genes involved in root growth and elongation of soybean plants 6 days after applied with the reagents in Example 6. (N=3) *** p<0.001.

### DETAILED DESCRIPTION

In some embodiments, the present invention provides a composition for enhancing plant growth. The composition comprises auxin, cytokinin, GABA, and choline chloride.

In some embodiments, the auxin is selected from indole-3-butyric acid (IBA), indole-3-acetic acid (IAA), 2-phenylacetic acid (PAA), indole-3-propionic acid (IPA), and 1-naphthaleneacetic acid (NAA). In some embodiments, the auxin is IBA.

In some embodiments, the cytokinin is selected from N6-furfuryladenine (kinetin), 6-Benzylaminopurine (BA), zeatin (ZT), N6-(2-isopentenyl) adenine (2ip), diphenylurea (DPU). In some embodiments, the cytokinin is kinetin.

In some embodiments, the composition of the present invention is a concentrate composition, comprising between about 0.8 g/L to about 80 g/L auxin, between about 0.18g/L to about 18 g/L cytokinin, between about 0.5 g/L to about 50 g/L GABA, and between about 2.5 g/L to about 250 g/L choline chloride. A concentrate solution refers to a solution which is intended to be diluted with water to form a use solution prior to application to the plant.

In some embodiments, the concentration of auxin in the concentrate composition is between about 0.8 g/L to about 80 g/L, between about 1.6 g/L to about 40 g/L, between about 3 g/L to about 20 g/L, between about 6 g/L to about 10 g/L, and preferably is, but is not limited to, about 0.8 g/L, about 1.5 g/L, about 3 g/L, about 6 g/L, about 8 g/L, about 10 g/L, about 20 g/L, about 30 g/L, about 40 g/L, about 50 g/L, about 60 g/L, about 70 g/L, about 80 g/L, or any concentration between about 0.8 g/L to about 80 g/L, such as about 1.853 g/L, about 13.748 g/L, or about 62.739 g/L. In some embodiments, the concentration of auxin in the concentrate composition is about 0.8 g/L, about 8 g/L, or about 80 g/L.

In some embodiments, the concentration of cytokinin in the concentrate composition is between about 0.18 g/L to about 18 g/L, between about 0.5 g/L to about 9 g/L, between about 1 g/L to about 5 g/L, between about 1.5 g/L to about 3 g/L, and preferably is, but is not limited to, about 0.18 g/L, about 0.5 g/L, about 1 g/L, about 1.5 g/L, about 2 g/L, about 5 g/L, about 7.5 g/L, about 10 g/L, about 15 g/L, about 18 g/L, or any concentration between about 0.18 g/L to about 18 g/L, such as about 1.267 g/L, about 7.823 g/L, about 14.869 g/L. In some embodiments, the concentration of cytokinin in the concentrate composition is about 0.18 g/L, 1.8 g/L, or 18 g/L.

In some embodiments, the concentration of GABA in the concentrate composition is between about 0.5 g/L to about 50 g/L, between about 1 g/L to about 25 g/L, between about 2 g/L to about 12 g/L, between about 4 g/L to about 6 g/L, and preferably is, but is not limited to, about 0.5 g/L, about 1 g/L, about 5 g/L, about 10 g/L, about 15 g/L, about 20 g/L, about 25 g/L, about 30 g/L, about 35 g/L, about 40 g/L, about 45 g/L, about 50 g/L, or any concentration between about 0.5 g/L to about 50 g/L, such as about 1.097 g/L, about 16.062 g/L, about 28.502 g/L. In some embodiments, the concentration of GABA in the concentrate composition is about 0.5 g/L, 5 g/L, or 50 g/L.

In some embodiments, the concentration of choline chloride in the concentrate composition is between about 2.5 g/L to about 250 g/L, between about 5 g/L to about 125 g/L, between about 10 g/L to about 60 g/L, between about 20 g/L to about 30 g/L, and preferably is, but is not limited to, about 2.5 g/L, about 5 g/L, about 10 g/L, about 25 g/L, about 50 g/L, about 100 g/L, about 150 g/L, about 200 g/L, about 225 g/L, about 250 g/L, or any concentration between about 2.5 g/L to about 250 g/L, such as about 6.978 g/L, about 24.234 g/L, about 182.607 g/L. In some embodiments, the concentration of choline chloride in the concentrate composition is about 2.5 g/L, 25 g/L, or 250 g/L.

In some embodiments, the concentrate composition for enhancing plant growth is diluted around 500 to 1,500 folds with water before use.

In some embodiments, the composition of the present invention is a ready to use composition, comprising between about 0.8 mg/L to about 80 mg/L auxin, between about 0.18 mg/L to about 18 mg/L cytokinin, between about 0.5 mg/L to about 50 mg/L GABA, and between about 2.5 mg/L to about 250 mg/L choline chloride. A ready to use solution is not diluted with water prior to application to the plant. A ready to use solution is a use solution when it is applied to the plant without further dilution.

In some embodiments, the concentration of auxin in the ready to use composition is between about 0.8 mg/L to about 80 mg/L, between about 1.6 mg/L to about 40 mg/L, between about 3 mg/L to about 20 mg/L, between about 6 mg/L to about 10 mg/L, and preferably is, but is not limited to, about 0.8 mg/L, about 1.5 mg/L, about 3 mg/L, about 6 mg/L, about 8 mg/L, about 10 mg/L, about 20 mg/L, about 30 mg/L, about 40 mg/L, about 50 mg/L, about 60 mg/L, about 70 mg/L, about 80 mg/L, or any concentration between about 0.8 mg/L to about 80 mg/L, such as about 1.853 mg/L, about 13.748 mg/L, or about 62.739 mg/L. In some embodiments, the concentration of auxin in the ready to use composition is about 0.8 mg/L, about 8 mg/L, or about 80 mg/L.

In some embodiments, the concentration of cytokinin in the ready to use composition is between about 0.18 mg/L to about 18 mg/L, between about 0.5 mg/L to about 9 mg/L, between about 1 mg/L to about 5 mg/L, between about 1.5 mg/L to about 3 mg/L, and preferably is, but is not limited to, about 0.18 mg/L, about 0.5 mg/L, about 1 mg/L, about 1.5 mg/L, about 2 mg/L, about 5 mg/L, about 7.5 mg/L, about 10 mg/L, about 15 mg/L, about 18 mg/L, or any concentration between about 0.18 mg/L to about 18 mg/L, such as about 1.267 mg/L, about 7.823 mg/L, about 14.869 mg/L. In some embodiments, the concentration of cytokinin in the ready to use composition is about 0.18 mg/L, 1.8 mg/L, or 18 mg/L.

In some embodiments, the concentration of GABA in the ready to use composition is between about 0.5 mg/L to about 50 mg/L, between about 1 mg/L to about 25 mg/L, between about 2 mg/L to about 12 mg/L, between about 4 mg/L to about 6 mg/L, and preferably is, but is not limited to, about 0.5 mg/L, about 1 mg/L, about 5 mg/L, about 10 mg/L, about 15 mg/L, about 20 mg/L, about 25 mg/L, about 30 mg/L, about 35 mg/L, about 40 mg/L, about 45 mg/L, about 50 mg/L, or any concentration between about 0.5 mg/L to about 50 mg/L, such as about 1.097 mg/L, about 16.062 mg/L, about 28.502 mg/L. In some embodiments, the concentration of GABA in the ready to use composition is about 0.5 mg/L, 5 mg/L, or 50 mg/L.

In some embodiments, the concentration of choline chloride in the ready to use composition is between about 2.5 mg/L to about 250 mg/L, between about 5 mg/L to about 125 mg/L, between about 10 mg/L to about 60 mg/L, between about 20 mg/L to about 30 mg/L, and preferably is, but is not limited to, about 2.5 mg/L, about 5 mg/L, about 10 mg/L, about 25 mg/L, about 50 mg/L, about 100 mg/L, about 150 mg/L, about 200 mg/L, about 225 mg/L, about 250 mg/L, or any concentration between about 2.5 mg/L to about 250 mg/L, such as about 6.978 mg/L, about 24.234 mg/L, about 182.607 mg/L. In some embodiments, the concentration of choline chloride in the ready to use composition is about 2.5 mg/L, 25 mmg/L, or 250 mg/L.

In some embodiments, the composition for enhancing plant growth of the present invention may include one or more adjuvants, such as a surfactant or a drift control agent. In other embodiments, the composition for enhancing plant growth of the present invention may not include an adjuvant. For example, the composition for enhancing plant growth may include a surfactant and/or a drift control agent. Exemplary surfactants include, but are not limited to, cationic surfactants, anionic surfactants, zwitterionic surfactants, and nonionic surfactants, preferably including but not limited to, Tween® 20, Tween® 40, Tween® 60, Tween® 65, Tween® 80, Tween® 85, Laureth-4, Ceteth-2, Ceteth-20, Steareth-2, PEG40, PEG100, PEG150, PEG200, PEG600, Span® 20, Span® 40, Span® 60, Span® 65, Span® 80. An exemplary drift control agent includes LI 700®, which is commercially available from Loveland Products (Loveland, CO, USA).

In some embodiments, the concentration of the adjuvant in the ready to use composition for enhancing plant growth is between about 0.01 to 1% (v/v), and preferably is, but is not limited to, about 0.01, about 0.02, about 0.03, about 0.04, about 0.05, about 0.06, about 0.07, about 0.08, about 0.09, about 0.1, about 0.2, about 0.3, about 0.4, about 0.5, about 0.6, about 0.7, about 0.8, about 0.9, about 1% (v/v). In some embodiments, the concentration of the adjuvant in the ready to use composition for enhancing plant growth is about 0.1% (v/v).

In some embodiments, the composition for enhancing plant growth of the present invention may be applied as part of a tank mix, which may include additional nutrients, such as micro or macro nutrients and/or pesticides such as fungicides, herbicides, or insecticides.

In one example, the composition is applied with at least one fungicide, such as, but not limited to, azoles, benzimidazoles, chloronitriles, dithiocarbamates, phenylamides, strobilurins, and triazoles.

In one example, the composition is applied with at least one herbicide, such as, but not limited to, 2,4-D, acetochlor, acifluorfen-Na, alachlor, aminopyralid, amitrole, atrazine, benfluralin, bensulfuron-methyl, bensulide, bentazon, bromacil, carfentrazone-ethyl, chlorimuron-ethyl, chlorsulfuron, clethodim, clopyralid, dicamba, diquat, diuron, EPTC, fluazifop-P-butyl, flumetsulam, flumioxazin, fomesafen, glufosinate-ammonium, glyphosate, halauxifen-methyl, hexazinone, imazamox, imazapyr, imazethapyr, isoxaflutole, lactofen, MCPA, MCPB, metribuzin, metsulfuron-methyl, MSMA, nicosulfuron, norflurazon, oxadiazon, oxyfluorfen, paraquat, pendimethalin, penoxsulam, picloram, prometryn, propanil, prosulfuron, quinclorac, quinmerac, rimsulfuron, s-metolachlor, saflufenacil, sethoxydim, sulfentrazone, sulfosulfuron, thifensulfuron-methyl, trifluralin, and triflusulfuron-methyl. In one specific example, the composition is applied with glyphosate.

Suitable concentration ranges for the concentrate composition of the present invention are provided in Table 1, and suitable concentration ranges for the ready to use composition of the present invention are provided in Table 2. In some embodiments, the concentrate composition and the ready to use composition can consist of or consist essentially of the components listed in Table 1 and 2, respectively.

TABLE 1
Suitable concentrate compositions

| | First example | Second example | Third example |
|---|---|---|---|
| | range | range | range |
| Component | (g/L) | (g/L) | (g/L) |
| Auxin | 0.4-160 | 0.8-80 | 2-32 |
| Cytokinin | 0.09-36 | 0.18-18 | 0.45-7.2 |
| GABA | 0.25-100 | 0.5-50 | 1.25-20 |
| Choline chloride | 1.25-500 | 2.5-250 | 6.25-100 |

TABLE 2
Suitable ready to use compositions

| | First example | Second example | Third example |
|---|---|---|---|
| | range | range | range |
| Component | (mg/L) | (mg/L) | (mg/L) |
| Auxin | 0.4-160 | 0.8-80 | 2-32 |
| Cytokinin | 0.09-36 | 0.18-18 | 0.45-7.2 |
| GABA | 0.25-100 | 0.5-50 | 1.25-20 |
| Choline chloride | 1.25-500 | 2.5-250 | 6.25-100 |

In some embodiments, the present invention provides a method for enhancing plant growth, comprising a step of applying a use solution composition to a plant, and the use solution composition comprising between about 0.8 mg/L to about 80 mg/L auxin, between about 0.18 mg/L to about 18 mg/L cytokinin, between about 0.5 mg/L to about 50 mg/L GABA, and between about 2.5 mg/L to about 250 mg/L choline chloride.

In some embodiments, the composition for enhancing plant growth of the present invention is applied to a plant during the vegetative phase. In some embodiments, the composition for enhancing plant growth of the present invention is applied to a plant during the reproductive phase.

The composition of the present invention can be applied to different plants, such as, but not limited to, asparagus, berry (such as blackberry, blueberry, caneberrry, kiwi, and raspberry), brassica vegetables (such as broccoli, cabbage, cauliflower, and mustard greens), bulb vegetable (such as garlic, leek, and onion), cereal grains (such as barley, corn, millet, oats, rice, sorghum, and wheat), citrus fruit (such as grapefruit, lemon, lime, sweet orange, and tangerine), coffee, cotton, cucurbit vegetables (such as cantaloupe, cucumber, honeydew, muskmelon, squash, and watermelon), forage, fodder, and straw of cereal grains, fruiting vegetables (such as eggplant, pepper, and tomato), grass forage, fodder, and hay, grass grown for seed (such as perennial ryegrass, tall fescue, or bentgrass), grape, herbs and spices (such as basil, dill, mustard, and sage), hemp, hops, leafy vegetable (such as celery, head and leaf lettuce, kale, and spinach), legume vegetables (such as bean, peas, and soybeans), mint, peppermint, spearmint, nongrass animal feeds (such as alfalfa, clover, hay, and vetch), oil seed crops (such as canola, flax, and sunflower), peanut, pome fruits (such as apple and pear), root and tuber vegetables (such as carrot, ginseng, horseradish, parsley, potato, radish, sugar beet, sweet potato, and turnip), stone fruits (such as apricot, cherry, peach, and plumcot), strawberry, sugarcane, tobacco, tree nuts (such as almonds, cashews, and pecans). In another example, the composition for enhancing plant growth is applied to corn, soybeans, wheat and cotton.

In some embodiments, the composition for enhancing plant growth of the present invention is applied to plant foliage (for example, leaves, stems, flowers and/or fruits), for example as a foliar application or foliar spray. In some embodiments, the composition for enhancing plant growth of the present invention is applied to plant roots, such as by a soil application or soil drench, and/or to seeds, such as by a seed treatment.

In some embodiments, the composition of the present invention enhances plant growth by at least one of the methods selected from increasing shoot growth, increasing root growth, increasing photosynthesis in plants, increasing nutrient uptake and assimilation, increasing water management by plants, and reducing herbicide mediated phototoxicity in plants.

In some embodiments, the composition of the present invention increases shoot growth by at least one of the methods selected from increasing shoot fresh weight, increasing shoot dry weight, and increasing leaf area.

In some embodiments, the composition of the present invention increases root growth by at least one of the methods selected from increasing root length, increasing root dry weight, and up-regulating expression of genes involved in root growth and elongation.

In some embodiments, the composition of the present invention increases photosynthesis in plants by at least one of the methods selected from increasing electron transport rate (ETR) of plants and up-regulating expression of genes related to increasing growth and/or photosynthesis.

In some embodiments, the composition of the present invention increases nutrient uptake and assimilation by at least one of the methods selected from increasing activity of nitrate reductase (NR) in the plants, increasing activity of glutamine synthetase (GS) in the plants, increasing activity of glutamate synthase (GOGAT) in the plants, and increasing root growth.

In some embodiments, the composition of the present invention increases water management by plant via at least one of the methods selected from up-regulating expression of genes related to improving water use efficiency and increasing root growth.

In some embodiments, the composition of the present invention reduces herbicide mediated phototoxicity in plants by at least one of the methods selected from reducing electrolyte leakage in the plants, reducing 2-thiobarbituric acid reactive substances (TBARS) level in the plants, increasing activity of nitrate reductase (NR) in the plants, increasing activity of glutamine synthetase (GS) in the plants, increasing activity of glutamate synthase (GOGAT) in the plants, increasing auxin level in the plants, increasing gibberellin level in the plants, increasing cytokinin level in the plants, reducing abscisic acid level in the plants, and improving plant growth, for example as measured by shoot dry weight and leaf area.

It has been found that when auxin, cytokinin, GABA, and choline chloride are combined in the composition of the present invention, the plant growth regulating actions of the respective components are increased synergistically, and the combination of the components exhibits a marked synergistic effect not seen when the components are used individually.

Unless otherwise defined, all technical and scientific terms used herein have the same meaning as commonly understood by one of ordinary skill in the art to which this invention pertains. In the case of conflict, the present document, including definitions will control.

As used herein, the term “auxin” refers to a class of plant growth regulators that promote stem elongation, inhibit growth of lateral buds, and therefore maintain apical dominance. Naturally occurring (endogenous) auxins are produced by apical meristem, such as stem tips and root tips. Auxin moves to the darker side of the plant, causing the cells there to grow longer than corresponding cells on the lighter side of the plant, and this produces a curving of the plant stem tip toward the light. Examples of auxin include, but are not limited to, indole-3-butyric acid (IBA), indole-3-acetic acid (IAA), 2-phenylacetic acid (PAA), indole-3-propionic acid (IPA), 1-naphthaleneacetic acid (NAA).

As used herein, the term “cytokinin” refers to a class of plant growth regulators that enhance cell division, cell differentiation, and axillary bud growth, and inhibit apical dominance. There are two types of cytokinins based on their chemical structures: adenine-type and phenylurea-type cytokinin. Most cytokinins are synthesized in root tip and transported to photosynthetic tissues through xylem. Although roots are the major site of cytokinin biosynthesis, they are not the only site. Cambium and possibly all actively dividing tissues, such as embryo, leaves, fruits, are responsible for the synthesis of cytokinin. Examples of cytokinin include, but are not limited to, N6-furfuryladenine (kinetin), 6-Benzylaminopurine (BA), zeatin (ZT), N6-(2-isopentenyl) adenine (2ip), and diphenylurea (DPU).

As used herein, the term “γ-aminobutyric acid (GABA),” also known as 4-aminobutanoic acid, refers to a non-protein amino acid having the formula of C₄H₉NO₂ and the following chemical structure:

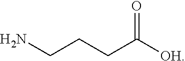

As used herein, the term “choline chloride” refers to an organic compound having the formula of ((CH₃)₃N(Cl)CH₂CH₂OH) and the following chemical structure:

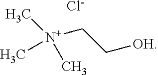

As used herein, the term “glyphosate” refers to the active ingredient in Roundup herbicide and has the chemical formula of C₃H₈NO₅P. Glyphosate inhibits 5-enolpyruvylshikimate-3-phosphate Synthase (EPSPS) in plants and disrupts synthesis of aromatic amino acids, such as phenylalanine, tyrosine, and tryptophan. Tryptophan is a precursor of indole-3-acetic acid (IAA), which is the main auxin in plants and plays an important role in regulating plant development via promoting cell division and elongation. When applied to plants, Glyphosate causes inhibition of protein synthesis and a decrease in IAA level in the plants, and leads to plant growth inhibition and death.

As used herein, the term “electrolyte leakage” refers to the phenomenon of efflux of electrolytes, such as potassium ion (K⁺), from a plant cell when the cell dies and loses the integrity of the cell membrane. Electrolyte leakage is an indicator of cell membrane stability of plants under stress conditions and a hallmark of stress response in plant cells. The greater electrolyte leakage, the less cell membrane integrity.

As used herein, the term “2-thiobarbituric acid reactive substances (TBARS)” refers to substances that are formed as a byproduct of lipid peroxidation and can be detected by the TBARS assay using thiobarbituric acid (TBA) as a reagent. Malondialdehyde (MDA) is one of several end products formed through the decomposition of lipid peroxidation products, and fatty peroxide-derived decomposition products other than MDA are TBA positive. TBARS is an indicator of lipid peroxidation of cell membrane. Higher TBARS levels indicate lower cell membrane integrity.

As used herein, the term “nitrogen assimilation” refers to the formation of organic nitrogen compounds, such as amino acids and proteins, from inorganic nitrogen compounds present in the environment. In nitrogen assimilation in plants, nitrate (NO₃⁻) and nitrite (NO₂⁻) are first reduced to ammonium (NH₄⁺) by nitrate reductase (NR) and nitrite reductase (NiR), respectively, and then ammonium (NH₄⁺) is incorporated into amino acid via the glutamine synthetase (GS)-glutamate synthase (GOGAT) pathway. Therefore, increasing activities of enzymes involved in nitrogen assimilation, such as nitrate reductase (NR), glutamine synthetase (GS), and glutamate synthase (GOGAT), in plant cells indicate that the plant synthesizes more amino acids and proteins.

As used herein, the term “electron transport rate (ETR)” refers to transport rate of electrons released by water splitting during photosynthesis. Since energy is generated during electron transportation, the faster the electron transport rate is, the more energy (ATP) is generated, which helps plants synthesize more sugar from CO₂.

As used herein, the terms “comprises,” “comprising,” “includes,” “including,” “has,” “having,” “contains,” “containing,” “characterized by” or any other variation thereof, are intended to cover a non-exclusive inclusion, subject to any limitation explicitly indicated. For example, a composition, mixture, process, method, article, or apparatus that comprises a list of elements is not necessarily limited to only those elements but may include other elements not expressly listed or inherent to such composition, mixture, process, method, article, or apparatus.

The transitional phrase “consisting of” excludes any element, step, or ingredient not specified. If in the claim, such would close the claim to the inclusion of materials other than those recited except for impurities ordinarily associated therewith. When the phrase “consisting of” appears in a clause of the body of a claim, rather than immediately following the preamble, it limits only the element set forth in that clause; other elements are not excluded from the claim as a whole.

The transitional phrase “consisting essentially of” is used to define a composition, method or apparatus that includes materials, steps, features, components, or elements, in addition to those literally disclosed, provided that these additional materials, steps, features, components, or elements do not materially affect the basic and novel characteristic(s) of the claimed invention. The term “consisting essentially of” occupies a middle ground between “comprising” and “consisting of”.

Where applicants have defined an invention or a portion thereof with an open-ended term such as “comprising,” it should be readily understood that (unless otherwise stated) the description should be interpreted to also describe such an invention using the terms “consisting essentially of” or “consisting of.”

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

The term “a,” “an,” or “the” disclosed in the present invention is intended to cover one or more numerical values in the specification and claims unless otherwise specified. For example, “an element” indicates one or more than one element.

It is to be understood that both the foregoing general description and the following detailed description are exemplary and explanatory only and are not restrictive of the invention.

### EXAMPLES

### Example 1 Synergistic Test with Glyphosate

### 1. Plant Growth and Treatment

Glyphosate-tolerant corn seeds (D40SS48, Dyna-Gro®) were seeded in pots containing culture medium (peat soil:vermiculite=3:1) and placed in a phytotron, which was operated at 25/23° C. day/night temperature and on a 16/8 light/dark cycle. One seed was seeded in one pot. Corn plants were applied with the reagents listed in Table 3 at the stage of V1 (first leaf collar) once at a rate of 15 mL/12 pots using a foliar spray treatment. There were 11 groups in this test, 1 Control group, 1 Glyphosate only group, and 9 Test groups.

Glyphosate-tolerant soybean seeds (S29RY05, Dyna-Gro®) were seeded in pots containing culture medium (peat soil:vermiculite=3:1) and placed in a phytotron, which was operated at 25/23° C. day/night temperature and on a 16/8 light/dark cycle. One seed was seeded in one pot. Soybean plants were applied with the reagents listed in Table 3 at the stage of V1 (one set of unfolded trifoliolate leaves) once at a rate of 10 mL/12 pots using a foliar spray treatment. There were 11 groups in this test, 1 Control group, 1 Glyphosate only group, and 9 Test groups.

TABLE 3
Summary of the reagents applied to plants in Example 1.

| | | | | | Choline | |
|---|---|---|---|---|---|---|
| | Glyphosate* | IBA | Kinetin | GABA | chloride | Tween ® 80 |
| | (g/L) | (mg/L) | (mg/L) | (mg/L) | (mg/L) | % (v/v) |
| Control | 0 | 0 | 0 | 0 | 0 | 0.1 |
| Glyphosate only | 4.87 | 0 | 0 | 0 | 0 | 0.1 |
| Test group 1 | 4.87 | 8 | 0 | 0 | 0 | 0.1 |
| Test group 2 | 4.87 | 0 | 1.8 | 0 | 0 | 0.1 |
| Test group 3 | 4.87 | 0 | 0 | 5 | 0 | 0.1 |
| Test group 4 | 4.87 | 0 | 0 | 0 | 25 | 0.1 |
| Test group 5 | 4.87 | 0 | 1.8 | 5 | 25 | 0.1 |
| Test group 6 | 4.87 | 8 | 0 | 5 | 25 | 0.1 |
| Test group 7 | 4.87 | 8 | 1.8 | 0 | 25 | 0.1 |
| Test group 8 | 4.87 | 8 | 1.8 | 5 | 0 | 0.1 |
| Test group 9 | 4.87 | 8 | 1.8 | 5 | 25 | 0.1 |

*100-fold dilution of Roundup PowerMAX ® Herbicide (Bayer, Leverkusen, Germany), which contains 48.7% (w/v) Glyphosate.

### 2. Analyses

2.1 Shoot dry weight: Seven (7) days after the application of reagents, leaves and stems of each plant were dried at 50° C. overnight, and then the dry weight was measured.

2.2 Statistics: Unpaired Student's t-test was applied to assess numerical data statistical significance. Statistical significance was set at p-value less than 0.05.

### 3. Results

### A. Corn

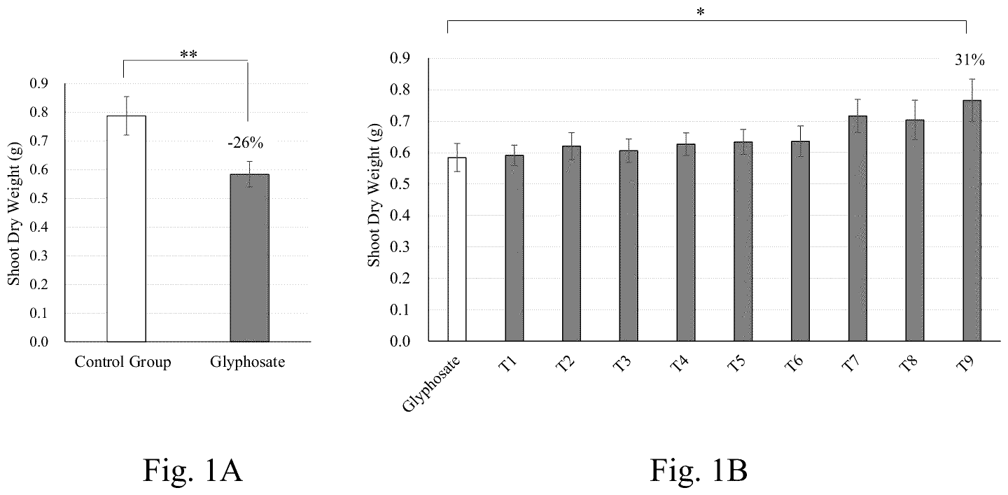

As shown in FIG. 1A, application of glyphosate led to a significant decrease in shoot dry weight of corn plants (p<0.01). As shown in FIG. 1B, corn plants treated with glyphosate and a composition of the present invention (Test group 9) have more shoot dry weight than plants in glyphosate only group (p<0.05) and Test groups 1-8. The results indicate that a composition of the present invention enhances plant growth by reducing the damages caused by glyphosate, and the combination of auxin, cytokinin, GABA, and choline chloride in the composition has a synergistic effect than the components used individually (Test groups 1-4) and the combinations other than a composition of the present invention (Test groups 5-8).

### B. Soybean

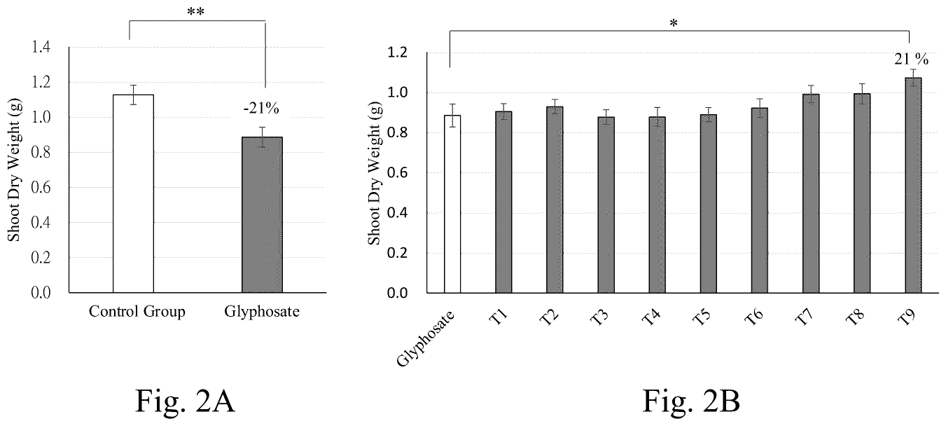

As shown in FIG. 2A, application of glyphosate led to a significant decrease in shoot dry weight of soybean plants (p<0.01). As shown in FIG. 2B, soybean plants treated with glyphosate and a composition of the present invention (Test group 9) have more shoot dry weight than plants in glyphosate only group (p<0.05) and Test groups 1-8. The results indicate that a composition of the present invention enhances plant growth by reducing the damages caused by glyphosate, and the combination of auxin, cytokinin, GABA, and choline chloride in the composition has a synergistic effect than the components used individually (Test groups 1-4) and the combinations other than a composition of the present invention (Test groups 5-8).

### Example 2 Test of Different Concentrations of Components With Glyphosate

### 1. Plant Growth and Treatment

Glyphosate-tolerant corn seeds (D40SS48, Dyna-Gro®) were seeded in pots containing culture medium (peat soil:vermiculite=3:1) and placed in a phytotron, which was operated at 25/23° C. day/night temperature and on a 16/8 light/dark cycle. One seed was seeded in one pot. Corn plants were applied with the reagents listed in Table 4 at the stage of V1 (first leaf collar) once at a rate of 15 mL/12 pots using a foliar spray treatment. There were 11 groups in this test, 1 Control group, 1 Glyphosate only group, and 9 Test groups.

Glyphosate-tolerant soybean seeds (S29RY05, Dyna-Gro®) were seeded in pots containing culture medium (peat soil:vermiculite=3:1) and placed in a phytotron, which was operated at 25/23°° C. day/night temperature and on a 16/8 light/dark cycle. One seed was seeded in one pot. Soybean plants were applied with the reagents listed in Table 4 at the stage of V1 (one set of unfolded trifoliolate leaves) once at a rate of 10 mL/12 pots using a foliar spray treatment. There were 11 groups in this test, 1 Control group, 1 Glyphosate only group, and 9 Test groups.

TABLE 4
Summary of the reagents applied to plants in Example 2.

| | | | | | Choline | |
|---|---|---|---|---|---|---|
| | Glyphosate* | IBA | Kinetin | GABA | chloride | Tween ® 80 |
| | (g/L) | (mg/L) | (mg/L) | (mg/L) | (mg/L) | % (v/v) |
| Control | 0 | 0 | 0 | 0 | 0 | 0.1 |
| Glyphosate only | 4.87 | 0 | 0 | 0 | 0 | 0.1 |
| Test group 1 | 4.87 | 0.8 | 1.8 | 5 | 25 | 0.1 |
| Test group 2 | 4.87 | 80 | 1.8 | 5 | 25 | 0.1 |
| Test group 3 | 4.87 | 8 | 0.18 | 5 | 25 | 0.1 |
| Test group 4 | 4.87 | 8 | 18 | 5 | 25 | 0.1 |
| Test group 5 | 4.87 | 8 | 1.8 | 0.5 | 25 | 0.1 |
| Test group 6 | 4.87 | 8 | 1.8 | 50 | 25 | 0.1 |
| Test group 7 | 4.87 | 8 | 1.8 | 5 | 2.5 | 0.1 |
| Test group 8 | 4.87 | 8 | 1.8 | 5 | 250 | 0.1 |
| Test group 9 | 4.87 | 8 | 1.8 | 5 | 25 | 0.1 |

*100-fold dilution of Roundup PowerMAX ® Herbicide (Bayer, Leverkusen, Germany), which contains 48.7% (w/v) Glyphosate.

### 2. Analyses

Methods for analyzing shoot dry weight and statistics are the same as described in Example 1.

### 3. Results

### A. Corn

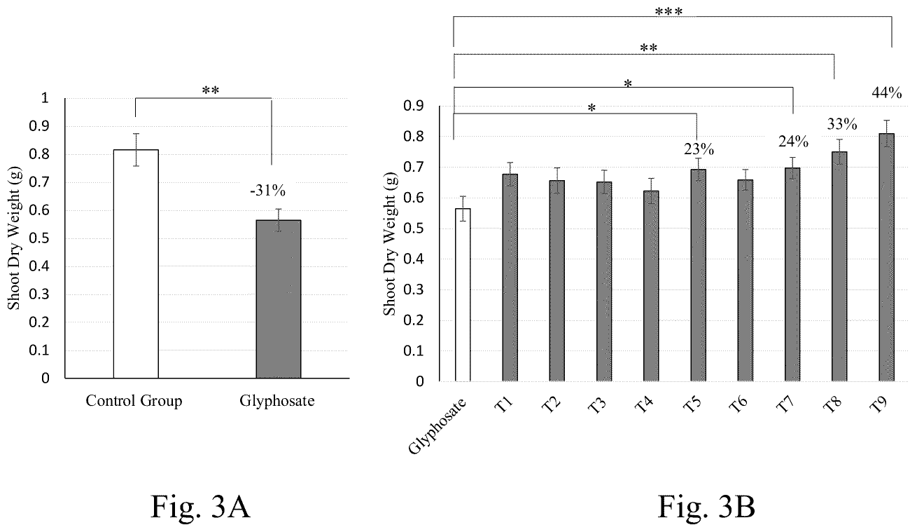

As shown in FIG. 3A, application of glyphosate led to a significant decrease in shoot dry weight of corn plants (p<0.01). As shown in FIG. 3B, corn plants treated with glyphosate and compositions containing different component concentrations (Test groups 1-9) all have more shoot dry weight than plants in glyphosate only group (p<0.05, p<0.01, or p<0.001). The results indicate that compositions of the present invention enhance plant growth by reducing the damages caused by glyphosate.

### B. Soybean

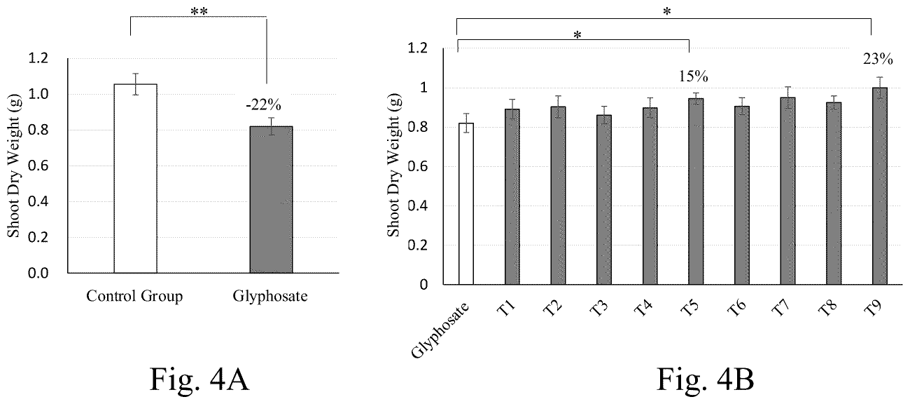

As shown in FIG. 4A, application of glyphosate led to a significant decrease in shoot dry weight of soybean plants (p<0.01). As shown in FIG. 4B, soybean plants treated with glyphosate and compositions containing different component concentrations (Test groups 1-9) all have more shoot dry weight than plants in glyphosate only group (p<0.05). The results indicate that the compositions of the present invention enhance plant growth by reducing the damages caused by glyphosate.

### Example 3 Test of Glyphosate-Tolerant Crops With Glyphosate

### 1. Plant Growth and Treatment

Glyphosate-tolerant corn seeds (D40SS48, Dyna-Gro®) were seeded in pots containing culture medium (peat soil:vermiculite =3:1) and placed in a phytotron, which was operated at 25/23°° C. day/night temperature and on a 16/8 light/dark cycle. One seed was seeded in one pot. Corn plants were applied with the reagents listed in Table 5 at the stage of V1 (first leaf collar) once at a rate of 15 mL/12 pots using a foliar spray treatment. There were 4 groups in this test, 1 Control group, 1 Glyphosate only group, and 2 Test groups.

Glyphosate-tolerant soybean seeds (S29RY05, Dyna-Gro®) were seeded in pots containing culture medium (peat soil:vermiculite=3:1) and placed in a phytotron, which was operated at 25/23° C. day/night temperature and on a 16/8 light/dark cycle. One seed was seeded in one pot. Soybean plants were applied with the reagents listed in Table 5 at the stage of V1 (one set of unfolded trifoliolate leaves) once at a rate of 10 mL/12 pots using a foliar spray treatment. There were 4 groups in this test, 1 Control group, 1 Glyphosate only group, and 2 Test groups.

TABLE 5
Summary of the reagents applied to plants in Example 3.

| | | | | | Choline | |
|---|---|---|---|---|---|---|
| | Glyphosate* | IBA | Kinetin | GABA | chloride | Tween ® 80 |
| | (g/L) | (mg/L) | (mg/L) | (mg/L) | (mg/L) | % (v/v) |
| Control | 0 | 0 | 0 | 0 | 0 | 0.1 |
| Glyphosate only | 4.87 | 0 | 0 | 0 | 0 | 0.1 |
| Test group 1** | 4.87 | 8.5 | 1.5 | 0 | 0 | 0.1 |
| Test group 2 | 4.87 | 8 | 1.8 | 5 | 25 | 0.1 |

*100-fold dilution of Roundup PowerMAX ® Herbicide (Bayer, Leverkusen, Germany), which contains 48.7% (w/v) Glyphosate.
**Plants in Test group 1 were treated with a mixture of a 100-fold dilution of Roundup PowerMAX ® Herbicide, a 1,000-fold dilution of Radiate ® (which contains 0.85% (w/v) IBA and 0.15% (w/v) kinetin; Loveland Products, Loveland, CO, USA), and 0.1% (v/v) Tween ® 80.

### 2. Analyses

2.1 Analyses of Leaves: Seven (7) days after the application of reagents, plant height was measured, and leaves were collected. The leaf area of the fourth leaf of each corn plant and the total leaf area of each soybean plant were measured by a leaf analyzer (WinFOLIA™, Regent Instruments Inc., Québec, Canada). Leaves and stems of each plant were dried at 50° C. overnight, and then the dry weight was measured.

2.2 Analyses of Roots: Seven (7) days after the application of reagents, length of plant root was measured by a root analyzer (WinRHIZO™, Regent Instruments Inc., Québec, Canada). In addition, roots of each plant were dried at 50° C. overnight, and then the dry weight was measured.

2.3 Electrolyte Leakage: Three (3) days after the application of reagents, sample leaves were cleaned with deionized water three times. Six (6) leaf disks (7.5 mm diameter) were cut from the sample leaves and immersed in 10 ml of deionized water at 25° C. for 24 hours. After that, the first electrolytic conductivity (EC1) of the sample solution was analyzed with an electrical conductivity meter (SevenCompact™ S230 Conductivity Meter, Mettler-Toledo, Columbus, OH, USA). The sample leaf disks were then kept in the deionized water at 95° C. for 2 hours. After the temperature of the sample solution decreased to 25° C., the second electrolytic conductivity (EC2) of the sample solution was analyzed with the electrical conductivity meter again. Ten (10) milliliters of deionized water without any sample were used as control. Electrolyte leakage of the sample leaves was analyzed with the following equation.

$$Electrolyte leakage ( \% ) = ( Sample EC 1 - Control EC 1 ) \times 100 / ( Sample EC 2 - Control EC 2 )$$

2.4 Content of TBARS: 2-thiobarbituric acid reactive substances (TBARS) are a byproduct and an indication of lipid peroxidation. Three (3) days after the application of reagents, 30 grams of fresh sample leaf were ground in liquid nitrogen and mixed with 1 ml of 20% (v/v) Trichloroacetic acid (TCA). The mixture was centrifuged at 10,000×g for 5 minutes. Two-hundred (200) microliters of the supernatant were then mixed with 800 μl of TBARS solution [20% (v/v) TCA containing 0.5% (w/v) 2-thiobarbituric acid], incubated at 95° C. in a water bath for 30 minutes, cooled on ice, and then centrifuged at 2,000×g for 20 minutes. Absorbance at an optical density (O.D.) of 532 nm (A532) and 600 nm (A600) was measured by a microplate reader (Infinite® M200 pro, TECAN, Männedorf, Switzerland). Concentration of TBARS in a sample was calculated with the following equation.

$$TBARS ( nmol / gFW ) = ( {A}_{532} - {A}_{600} ) \times N \times 1.8 \times 1000 / 155 \times W$$

N: dilution factor
W: Fresh weight of a sample (g)

2.5 Activity of Nitrate Reductase (NR): Three (3) days after the application of reagents, 0.5 grams of fresh sample leaf were ground in liquid nitrogen. One (1) ml of potassium phosphate buffer (100 mM, pH7.4) containing 7.5 mM cysteine, 1 mM EDTA, and 1.5% casein was added to the sample, mixed with the sample, and then the mixed sample was centrifuged at 4° C., 13,000 relative centrifugal field (rcf) for 30 minutes. Zero-point one (0.1) ml of the supernatant and 0.9 ml of reaction solution were incubated at 30° C. in a water bath for 30 minutes, and the reaction was stopped by adding 0.05 mL zinc acetate (1 M). The sample was centrifuged at room temperature, 3,000 rcf. The supernatant was transferred to a new tube and mixed with 0.5 mL sulphanilamide (5.8 mM) and 0.5 mL N-(1-naphthyl)ethylenediamine (0.8 mM). The mixture was incubated for 30 minutes. The NR activity is determined by NO₂⁻ production through measuring absorbance at an optical density (O.D.) of 540 nm (A₅₄₀). KNO₂⁻ is used as a NO₂⁻ concentration standard.

2.6 Activity of Glutamine Synthetase (GS): Three (3) days after the application of reagents, 0.5 grams of fresh sample leaf was ground in liquid nitrogen. The leaf powder and 1 ml of extraction solution, containing 10 mM Tris-HCl (pH7.6), 1 mM MgCl₂, 1 mM EDTA, and 10 mM 2-Mercaptoethanol, were centrifuged at 4° C., 13,000 rcf for 30 minutes. Zero-point one (0.1) ml of the supernatant and 0.4 ml of reaction solution were incubated at 30° C. in a water bath for 30 minutes, and the reaction was stop by adding 1 mL of stop solution, containing 2.5 g FeCl₃, 5.0 g TCA in 100 mL HCl (1.5 N). The sample was centrifuged at room temperature, 3,000 rcf. Absorbance at an O.D. of 540 nm (A₅₄₀) of the supernatant was measured.

2.7 Activity of Glutamate Synthase (GOGAT): Three (3) days after the application of reagents, 0.5 gram of fresh sample leaf was ground in liquid nitrogen. The leaf powder and 1 ml of extraction solution, containing 10 mM Tris-HCl (pH7.6), 1 mM MgCl2, 1 mM EDTA, and 10 mM 2-Mercaptoethanol, were centrifuged at 4° C., 13,000 rcf for 30 minutes. Zero-point-one-five (0.15) ml of the supernatant was mixed with the reaction solution containing 0.2 mL of 20 mM L-glutamine, 0.25 mL of 2 mM 2-oxoglutarate, 0.05 mL of 10 mM KCI, 1 mL of 25 mM Tris-HCl (pH7.6), and 0.1 mL 3 mM NADH to initiate the reaction. The GOGAT activity is determined by NADH reduction through measuring fluorescence intensity at excitation/emission wavelengths of 340/445 nm. NADH concentration is determined by reference to a NADH standard curve.

2.8 Content of Plant Hormones: Twelve (12) days after the application of reagents, 1 g of fresh sample leaf was ground in liquid nitrogen and then mixed with 10 g extraction solution (80% (v/v) methanol, 1% (v/v) acetic acid) by a vortex mixer. The sample was then sonicated for 1 hour and centrifuged at 2,500 rpm for 10 minutes. The supernatant was collected, concentrated, dissolved in 1 ml of 100% methanol, and then analyzed for content of plant hormones with a tandem quadrupole mass spectrometer (Waters® Xevo® TQ MS, Waters Corporation, Milford, MA, USA) and ACQUITY UPLC System (Waters Corporation, Milford, MA, USA).

2.9 Statistics: Methods of statistics are the same as described in Example 1.

### 3. Results

### A. Corn

A-3.1A composition of the present invention increases crop growth after glyphosate treatment.

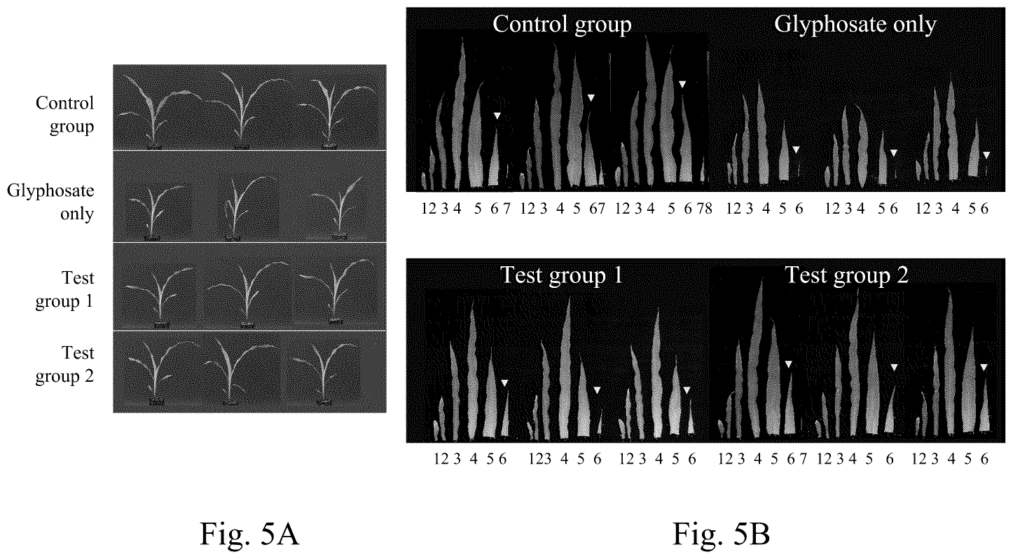

As shown in FIG. 5A and Table 6, corn plants treated with glyphosate and a composition of the present invention (Test group 2) are taller than corn plants treated with glyphosate and Test group 1 and corn plants treated with glyphosate only. In addition, as shown in FIG. 5B and Table 6, plants in Test group 2 have larger areas of the fourth leaves, heavier shoot dry weights, and heavier root dry weights than plants in Glyphosate only group and Test group 1. The results indicate that a composition of the present invention enhances plant growth after Glyphosate treatment.

TABLE 6
Analyses of corn plants growth after Glyphosate treatment

| | Plant | The 4^{th} | Shoot | Total root | Root dry |
|---|---|---|---|---|---|
| | height | leaf | dry | length | weight |
| | (cm) | area (cm²) | weight (g) | (cm) | (g) |
| Control | 50.79 | 110.17 | 2.38 | 1789.34 | 0.49 |
| Glyphosate | 42.70 | 89.45 | 1.30 | 1405.69 | 0.35 |
| only | | | | | |
| Test group 1 | 44.51 | 94.46 | 1.52 | 1668.89 | 0.38 |
| Test group 2 | 47.73 | 103.76** | 1.72*** | 1776.46 | 0.42* |

The significant values between Glyphosate only group and Test group 2 are indicated with
*p < 0.05;
**p < 0.01;
***p < 0.001.
N = 10

A-3.2 A composition of the present invention alleviates plant cell membrane damage after Glyphosate treatment.

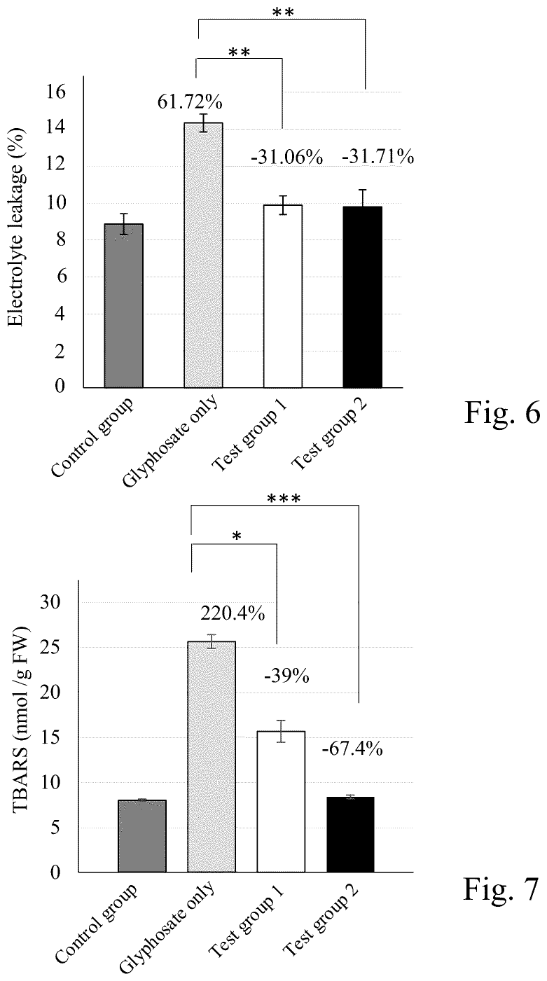

As shown in FIG. 6, glyphosate causes increase in electrolyte leakage in plants, indicating loss of cell membrane integrity in the plants. Corn plants treated with glyphosate and Test group 1 and corn plants treated with glyphosate and a composition of the present invention (Test group 2) both have significantly less electrolyte leakage than corn plants treated with glyphosate only (Test group 1 vs. Glyphosate only group, p<0.01; Test group 2 vs. Glyphosate only group, p<0.01). Test group 1 and a composition of the present invention (Test group 2) decrease electrolyte leakage in corn leaves by 31.06% and 31.71%, respectively, as compared with glyphosate only group. The results indicate that a composition of the present invention increases cell membrane stability in plants after glyphosate treatment.

As shown in FIG. 7, glyphosate causes increase in TBARS level in corn plants, indicating loss of cell membrane integrity in the plants. Corn plants treated with glyphosate and Test group 1 and corn plants treated with glyphosate and a composition of the present invention (Test group 2) both have significantly less TBARS level than corn plants treated with glyphosate only (Glyphosate only group) (Test group 1 vs. Glyphosate only group, p<0.05; Test group 2 vs. Glyphosate only group, p<0.001). Test group 1 and a composition of the present invention (Test group 2) decrease TBARS level in corn leaves by 39% and 67.4%, respectively, as compared with glyphosate only group. The results indicate that a composition of the present invention reduces cell membrane damage caused by glyphosate. A-3.3 A composition of the present invention improves activities of key enzymes in nitrogen assimilation in plants after Glyphosate treatment.

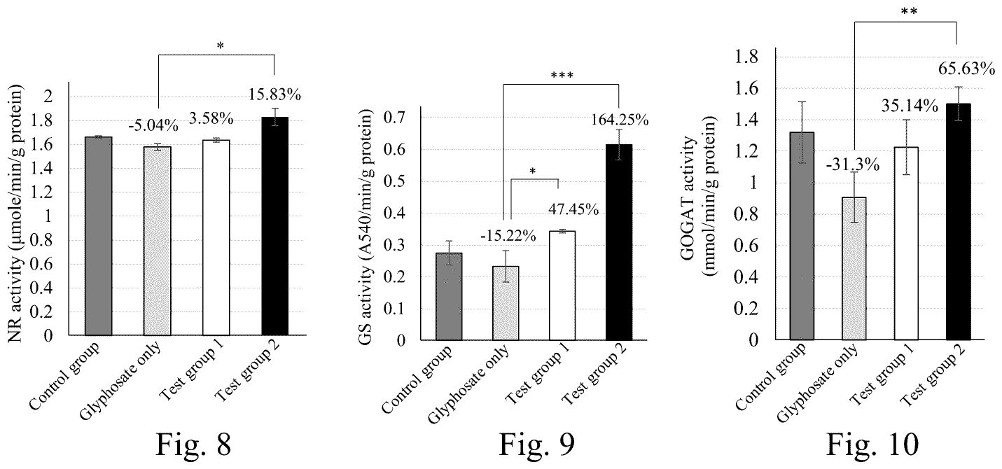

As shown in FIGS. 8-10, glyphosate causes decrease in activities of nitrate reductase (NR), glutamine synthetase (GS), and glutamate synthase (GOGAT) in corn plants, indicating less nitrogen utilization efficiency in the plants. In addition, as shown in FIG. 8, a composition of the present invention (Test group 2) significantly increases activities of nitrate reductase (NR) of corn plants by 15.83% as compared with glyphosate only group (p<0.05). As shown in FIG. 9, a composition of the present invention (Test group 2) significantly increases activities of glutamine synthetase (GS) of corn plants by 164.25% as compared with glyphosate only group (p<0.001). As shown in FIG. 10, a composition of the present invention (Test group 2) significantly increases activities of glutamate synthase (GOGAT) of corn plants by 65.63% as compared with glyphosate only group (p<0.01). The results demonstrate that a composition of the present invention improves nitrogen utilization efficiency in plants by increasing activities of nitrogen assimilation enzymes after glyphosate treatment.

A-3.4 A composition of the present invention increases growth hormone levels and reduces a stress hormone level in plants after glyphosate treatment.

As shown in Table 7, corn plants treated with Radiate® without glyphosate and corn plants treated with Sample 1 (8 g/mL IBA, 1.8 mg/L kinetin, 5 mg/L GABA, 25 mg/L choline chloride and 0.1% v/v Tween®80) (a composition of the present invention) without glyphosate both have higher content of indole-3-acetic acid (IAA), gibberellin A1 (GA1), and cytokinin (Zeatin+iPAs) and lower content of abscisic acid (ABA) than Control group. In addition, corn plants treated with Sample 1 without glyphosate have higher content of gibberellin A1 (GA1) and cytokinin (Zeatin+iPAs) and lower content of abscisic acid (ABA) than corn plants treated with Radiate® without glyphosate. The results show that a composition of the present invention (Sample 1) increases growth hormone (auxin, gibberellin, and cytokinin) levels and reduces a stress hormone (abscisic acid) level in plants without glyphosate treatment.

Furthermore, as shown in Table 7, corn plants treated with glyphosate and Radiate® (Test group 1) and corn plants treated with glyphosate and a composition of the present invention (Test group 2) both have higher content of IAA, GA1, and cytokinin (Zeatin+iPAs) and lower content of ABA than corn plants treated with glyphosate only. In addition, plants in Test group 2 have higher content of IAA and cytokinin (Zeatin+iPAs) and lower content of ABA than plants in Test group 1. The results show that a composition of the present invention increases growth hormone (auxin, gibberellin, and cytokinin) levels and reduces a stress hormone (abscisic acid) level in plants with glyphosate treatment.

TABLE 7
Analyses of phytohormone levels in corn plants with
and without glyphosate treatment.

| | Treatment | IAA | GA1 | Cytokinin | ABA |
|---|---|---|---|---|---|
| Phytohormone | Control | 658 | 1578 | 3.7 | 535 |
| content | Radiate ® | 3244 | 2134 | 9.5 | 289 |
| without Glyphosate | | (493%) | (135%) | (256%) | (54%) |
| treatment (ng/g FW) | Sample 1 | 3189 | 2318 | 10.3 | 258 |
| (% of control) | | (485%) | (147%) | (278%) | (48%) |
| Phytohormone | Glyphosate | 45 | 625 | 0.75 | 2742 |
| content | only group | | | | |
| with glyphosate | Test | 422 | 912 | 2.34 | 879 |
| treatment (ng/g FW) | group 1 | (937%) | (145%) | (312%) | (32%) |
| (% of Glyphosate | Test | 483 | 895 | 2.68 | 845 |
| only group) | group 2 | (1073%) | (143%) | (357%) | (30.8%) |

N = 3.

### B. Soybean

B-3.1 A composition of the present invention alleviates soybean growth inhibition after glyphosate treatment.

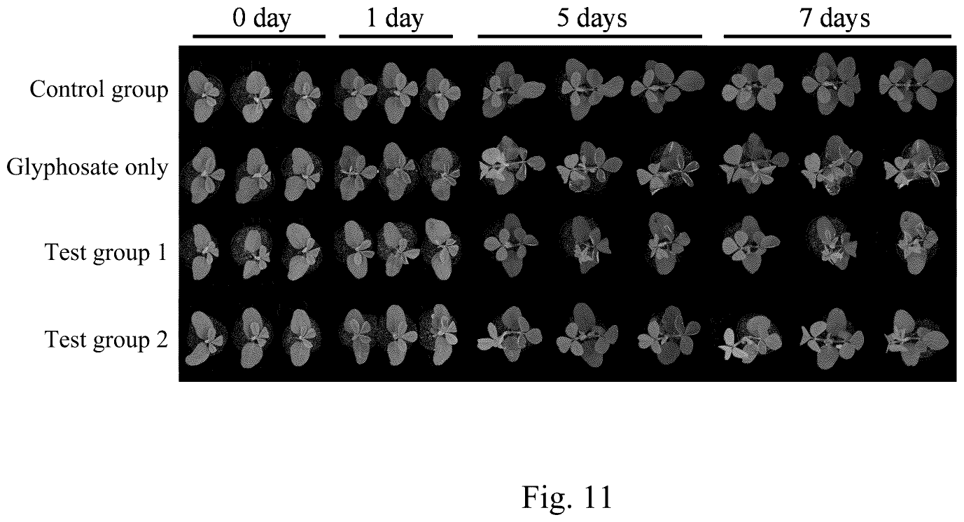

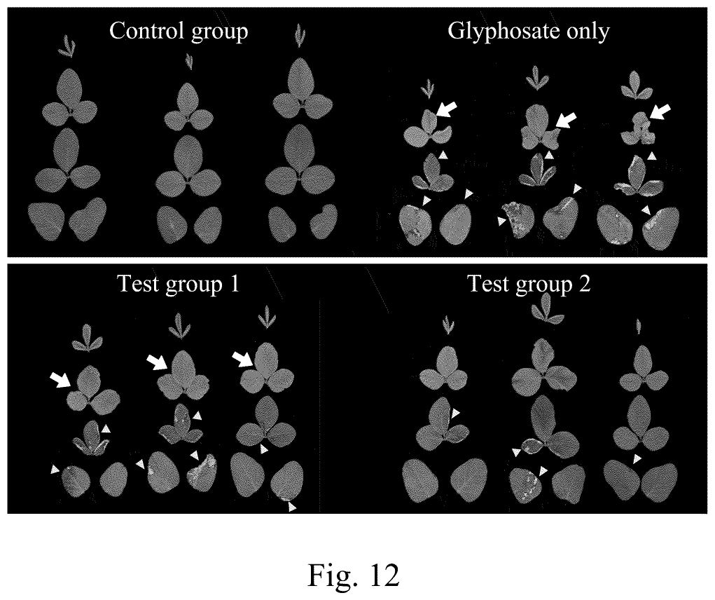

As shown in FIG. 11 and Table 8, soybean plants treated with glyphosate and a composition of the present invention (Test group 2) have significantly larger total leaf area than soybean plants treated with glyphosate and Test group 1 and soybean plants treated with glyphosate only (Test group 2 vs. Glyphosate only group, p<0.001). In addition, as shown in Table 8, plants in Test group 2 have longer unifoliate leaf length, heavier shoot fresh weights, longer total root length, and heavier root dry weights than plants in Glyphosate only group and Test group 1. More importantly, as shown in FIG. 12, glyphosate causes leaf curling symptoms and necrotic areas in soybean leaves. However, soybean plants in Test group 2 do not show leaf curling symptoms and have fewer necrotic areas than soybean plants in Glyphosate only group and Test group 1. The results indicate that a composition of the present invention relieves negative effect on leaf development caused by glyphosate.

TABLE 8
Analyses of soybean plants growth after glyphosate treatment.

| | The | | Shoot | Total | Root |
|---|---|---|---|---|---|
| | unifoliate | Total | fresh | root | dry |
| | leaf length | leaf area | weight | length | weight |
| | (cm) | (cm²) | (g) | (cm) | (g) |
| Control | 5.81 | 84.00 | 2.96 | 2333.35 | 0.39 |
| Glyphosate | 4.54 | 55.96 | 2.46 | 2047.40 | 0.28 |
| only group | | | | | |
| Test group 1 | 4.58 | 56.59 | 2.57 | 2085.93 | 0.31 |
| Test group 2 | 4.79 | 64.42*** | 2.90* | 2363.54 | 0.31 |

The significant values between Glyphosate only group and Test group 2 are indicated with
*p < 0.05;
***p < 0.001.
N = 10

B-3.2 A composition of the present invention alleviates plant cell membrane damage after glyphosate treatment.

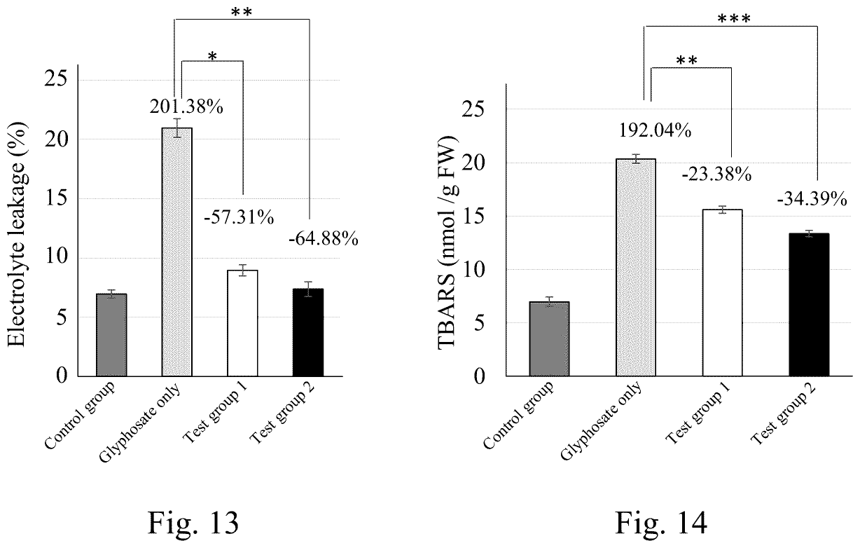

As shown in FIG. 13, glyphosate causes increase in electrolyte leakage in soybean plants, indicating loss of cell membrane integrity in the plants. Soybean plants treated with glyphosate and Test group 1 and soybean plants treated with glyphosate and a composition of the present invention (Test group 2) both have significantly less electrolyte leakage than soybean plants treated with glyphosate only (Test group 1 vs. Glyphosate only group, p<0.05; Test group 2 vs. Glyphosate only group, p<0.01). Test group 1 and a composition of the present invention (Test group 2) decrease electrolyte leakage in soybean leaves by 57.31% and 64.88%, respectively, as compared with Glyphosate only group. The results indicate that a composition of the present invention increases cell membrane stability in plants after glyphosate treatment.

As shown in FIG. 14, glyphosate causes increase in TBARS level in soybean plants, indicating loss of cell membrane integrity in the plants. Soybean plants treated with glyphosate and Test group 1 and soybean plants treated with glyphosate and a composition of the present invention (Test group 2) both have significantly less TBARS level than soybean plants treated with glyphosate only (Test group 1 vs. Glyphosate only group, p <0.01; Test group 2 vs. Glyphosate only group, p <0.001). Test group 1 and a composition of the present invention (Test group 2) decrease TBARS level in soybean leaves by 23.38% and 34.39%, respectively, as compared with Glyphosate only group. The results indicate that a composition of the present invention reduces cell membrane damage caused by glyphosate.

B-3.3 A composition of the present invention improves activities of key enzymes in nitrogen assimilation in plants after Glyphosate treatment.

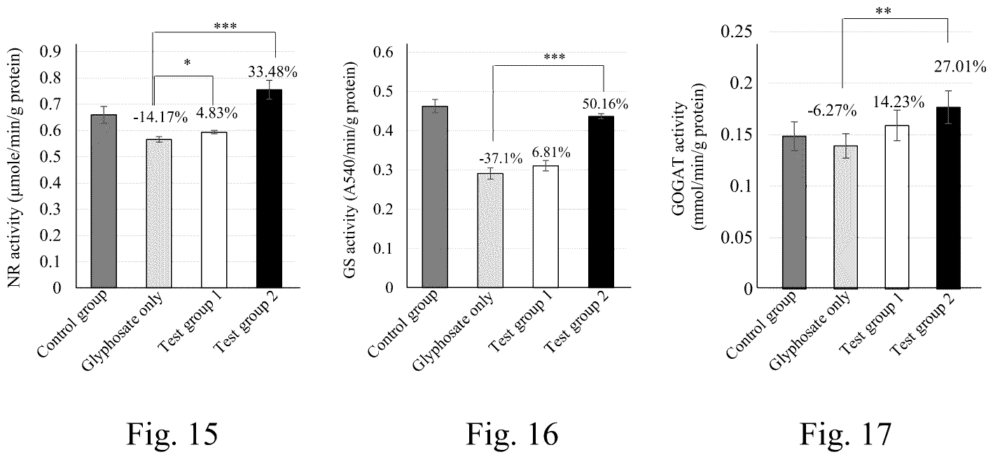

As shown in FIGS. 15-17, glyphosate causes decrease in activities of nitrate reductase (NR), glutamine synthetase (GS), and glutamate synthase (GOGAT) in soybean plants, indicating less nitrogen utilization efficiency in the plants. In addition, as shown in FIG. 15, a composition of the present invention (Test group 2) significantly increases activities of nitrate reductase (NR) of soybean plants by 33.48% as compared with Glyphosate only group (p<0.001). As shown in FIG. 16, a composition of the present invention (Test group 2) significantly increases activities of glutamine synthetase (GS) of soybean plants by 50.16% as compared with Glyphosate only group (p<0.001). As shown in FIG. 17, a composition of the present invention (Test group 2) significantly increases activities of glutamate synthase (GOGAT) of soybean plants by 27.01% as compared with Glyphosate only group (p<0.01). The results demonstrate that a composition of the present invention improves nitrogen utilization efficiency in plants by increasing activities of nitrogen assimilation enzymes after glyphosate treatment.

B-3.4 A composition of the present invention increases growth hormone levels and reduces a stress hormone level in plants after glyphosate treatment.

As shown in Table 9, soybean plants treated with Radiate® without glyphosate and soybean plants treated with Sample 1 (8 g/mL IBA, 1.8 mg/L kinetin, 5 mg/L GABA, 25 mg/L choline chloride and 0.1% v/v Tween®80) (a composition of the present invention) without glyphosate both have higher content of IAA, GA1, and cytokinin (Zeatin+iPAs) and lower content of ABA than Control group. In addition, soybean plants treated with Sample 1 without glyphosate have higher content of IAA and cytokinin (Zeatin+iPAs) and lower content of ABA than soybean plants treated with Radiate® without glyphosate. The results show that Sample 1 increases growth hormone (auxin, gibberellin, and cytokinin) levels and reduces a stress hormone (abscisic acid) level in plants without glyphosate treatment.

Furthermore, as shown in Table 9, soybean plants treated with glyphosate and Test group 1 and soybean plants treated with glyphosate and a composition of the present invention (Test group 2) both have higher content of IAA, GA1, and cytokinin (Zeatin+iPAs) and lower content of ABA than soybean plants treated with glyphosate only. In addition, plants in Test group 2 have higher content of IAA, GA1, and cytokinin (Zeatin+iPAs) and lower content of ABA than plants in Test group 1. The results show that a composition of the present invention increases growth hormone (auxin, gibberellin, and cytokinin) levels and reduces a stress hormone (abscisic acid) level in plants with glyphosate treatment.

TABLE 9
Analyses of phytohormone levels in soybean plants
with and without glyphosate treatment.

| | Treatment | IAA | GA1 | Cytokinin | ABA |
|---|---|---|---|---|---|
| Phytohormone content | Control | 185 | 1789 | 2.2 | 153 |
| without glyphosate | Radiate ® | 1210 | 1845 | 17.2 | 124 |
| treatment (ng/g FW) | | (654%) | (103%) | (782%) | (81%) |
| (% of control) | Sample 1 | 1253 | 1798 | 18.4 | 119 |
| | | (677%) | (100%) | (836%) | (78%) |
| Phytohormone | Glyphosate | 28 | 832 | 0.68 | 1189 |
| content | only group | | | | |
| with glyphosate | Test | 132 | 1224 | 1.25 | 318 |
| treatment (ng/g FW) | group 1 | (471%) | (147%) | (184%) | (27%) |
| (% of Glyphosate | Test | 143 | 1254 | 1.38 | 298 |
| only group) | group 2 | (511%) | (151%) | (203%) | (25%) |

N = 3.

### Example 4 Test of Different Concentrations of Components Without Glyphosate

### 1. Plant Growth and Treatment

Corn seeds (White Pearl, Known-You Seed Co., Ltd., Kaohsiung, Taiwan) were seeded in pots containing culture medium (peat soil:vermiculite=3:1) and placed in a phytotron, which was operated at 25/23° C. day/night temperature and on a 16/8 light/dark cycle. One seed was seeded in one pot. Corn plants were applied with the reagents listed in Table 10 at the stage of V1 (first leaf collar) once at a rate of 10 mL/12 pots using a foliar spray treatment. There were 6 groups in this test, 1 Control group and 5 Test groups.

Soybean seeds (Kaohsiung 10, Kaohsiung District Agricultural Research and Extension Station, Kaohsiung, Taiwan) were seeded in pots containing culture medium (peat soil:vermiculite=3:1) and placed in a phytotron, which was operated at 25/23° C. day/night temperature and on a 16/8 light/dark cycle. One seed was seeded in one pot. Soybean plants were applied with the reagents listed in Table 10 at the stage of V1 (one set of unfolded trifoliolate leaves) once at a rate of 10 mL/12 pots using a foliar spray treatment. There were 6 groups in this test, 1 Control group and 5 Test groups.

TABLE 10
Summary of the reagents applied to plants in Example 4.

| | IBA | Kinetin | GABA | Choline chloride | Tween ® 80 |
|---|---|---|---|---|---|
| | (mg/L) | (mg/L) | (mg/L) | (mg/L) | % (v/v) |
| Control | 0 | 0 | 0 | 0 | 0.1 |
| Test group 1* | 8.5 | 1.5 | 0 | 0 | 0.1 |
| Test group 2 | 8 | 1.8 | 5 | 25 | 0.1 |
| Test group 3 | 8 | 1.8 | 0.5 | 25 | 0.1 |
| Test group 4 | 8 | 1.8 | 5 | 2.5 | 0.1 |
| Test group 5 | 8 | 18 | 5 | 25 | 0.1 |

*Plants in Test group 1 were treated with a mixture of a 1,000-fold dilution of Radiate ® (which contains 0.85% (w/v) IBA and 0.15% (w/v) kinetin; Loveland Products, Loveland, CO, USA) and 0.1% (v/v) Tween ® 80.

### 2. Analyses

Methods for analyzing shoot dry weight and statistics are the same as described in Example 1.

### 3. Results

### A. Corn

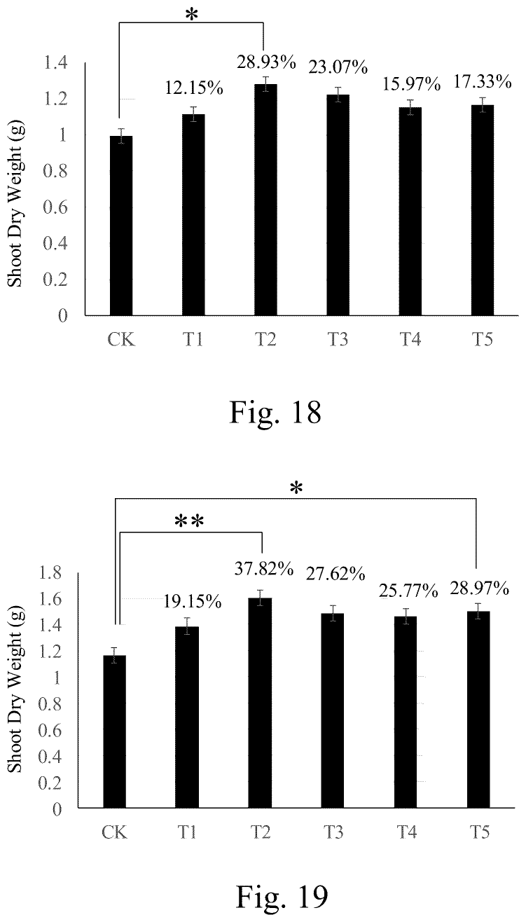

As shown in FIG. 18, corn plants treated with compositions containing different component concentrations (Test groups 2-5) all have more shoot dry weight than plants in Control group and Test group 1. The results indicate that the compositions of the present invention enhance plant growth by increasing shoot dry weight.

### B. Soybean

As shown in FIG. 19, soybean plants treated with compositions containing different component concentrations (Test groups 2-5) all have more shoot dry weight than plants in Control group and Test group 1. The results indicate that compositions of the present invention enhance plant growth by increasing shoot dry weight.

### Example 5 Effects of a Composition of the Present Invention Without Glyphosate on Plants

### 1. Plant Growth and Treatment

Corn seeds (White Pearl, Known-You Seed Co., Ltd., Kaohsiung, Taiwan) were seeded in pots containing culture medium (peat soil:vermiculite=3:1) and placed in a phytotron, which was operated at 25/23° C. day/night temperature and on a 16/8 light/dark cycle. One seed was seeded in one pot. Corn plants were applied with the reagents listed in Table 11 at the stage of V1 (first leaf collar) once at a rate of 10 mL/12 pots using a foliar spray treatment. There were 3 groups in this test, 1 Control group and 2 Test groups.

Soybean seeds (Kaohsiung 10, Kaohsiung District Agricultural Research and Extension Station, Kaohsiung, Taiwan) were seeded in pots containing culture medium (peat soil:vermiculite=3:1) and placed in a phytotron, which was operated at 25/23° C. day/night temperature and on a 16/8 light/dark cycle. One seed was seeded in one pot. Soybean plants were applied with the reagents listed in Table 11 at the stage of V1 (one set of unfolded trifoliolate leaves) once at a rate of 10 mL/12 pots using a foliar spray treatment. There were 3 groups in this test, 1 Control group and 2 Test groups.

TABLE 11
Summary of the reagents applied to plants in Example 5.

| | IBA | Kinetin | GABA | Choline chloride | Tween ® 80 |
|---|---|---|---|---|---|
| | (mg/L) | (mg/L) | (mg/L) | (mg/L) | % (v/v) |
| Control | 0 | 0 | 0 | 0 | 0.1 |
| Test group 1* | 8.5 | 1.5 | 0 | 0 | 0.1 |
| Test group 2 | 8 | 1.8 | 5 | 25 | 0.1 |

*Plants in Test group 1 were treated with a mixture of a 1,000-fold dilution of Radiate ® (which contains 0.85% (w/v) IBA and 0.15% (w/v) kinetin; Loveland Products, Loveland, CO, USA) and 0.1% (v/v) Tween ® 80.

### 2. Analyses

Methods for analyzing leaves, roots, activities of NR, GS, and GOGAT, and statistics are the same as described in Example 3.

2.1 Electron Transport Rate (ETR): Four (4) days after the application of reagents, leaves were analyzed with photosynthesis system (LI-6400XTQ, LI-COR Biosciences, Lincoln, NE, USA) under lights (1500 μmol photons m⁻²s⁻¹).

2.2 Gene Expression Analysis: One (1) or 3 days after the application of reagents, all trifoliolate leaves were collected for RNA extraction with LabPrep™M RNA plus mini kit (LabTurbo Biotech Co., Taipei, Taiwan). Reverse transcription polymerase chain reaction (RT-PCR) was performed with the extracted RNA using iScript™ gDNA Clear cDNA Synthesis Kit (Bio-Rad Laboratories, Hercules, California, USA). Then, real-time PCR was performed using iQ™ SYBR® (Bio-Rad Laboratories) in CFX Connect™ Real-Time PCR Detection System (Bio-Rad Laboratories) with the primers listed in Table 12.

TABLE 12
Summary of the primers used in real-time PCR
in Example 5

| Species | Gene* | Primer Sequence |
|---|---|---|
| Corn | ZmG2 | Forward |
| | | 5′-CATGGTGGACGACAACCTC-3′ |
| | | Reverse |
| | | 5′-CACATGTTTGCTCCAACGAC-3′ |
| | ZmGLK1 | Forward |
| | | 5′-GGACCTGGATTTCGACTTCA-3′ |
| | | Reverse |
| | | 5′-CACTCCCCTTTCCCTTCTTC-3′ |
| | ZmDOF1 | Forward |
| | | 5′-AAGAAGCGCCGCGTCGTGGCGCCG-3′ |
| | | Reverse |
| | | 5′-GCGCCAGGGAGTCGGAGTCCTCC-3′ |
| | ZmPPdK | Forward |
| | | 5′-TAGGGGATCGGAAGGATGGC-3′ |
| | | Reverse |
| | | 5′-CCCTGTCCCTGGTGCATTTT-3′ |
| | ZmPIP2; | Forward |
| | 1 | 5′-CGGGTCGCCTTTTTTTTG-3′ |
| | | Reverse |
| | | 5′-CCCTTGAGAGTCACGACATGA-3′ |
| | UBF7 | Forward |
| | | 5′-TGGATGTCGTCGTCTAAT-3′ |
| | | Reverse |
| | | 5′-CATAAGGATTCAAGCCATACT-3′ |
| Soybean | GmWRKY58 | Forward |
| | | 5′-CTTGGTCCTGACGCAAATGA-3′ |
| | | Reverse |
| | | 5′-TCCTTGAAATCAGACCAAAA-3′ |
| | GmWRKY76 | Forward |
| | | 5′-TCTGTGTTGACTTCTTCTTC-3′ |
| | | Reverse |
| | | 5′-TCCTCAGAACTCGGATCATT-3′ |
| | GmNAC | Forward |
| | | 5′-CACCACCAACAACTTGAGGC-3′ |
| | | Reverse |
| | | 5′-CTCGTGCTGGAACTGAACCT-3′ |
| | GmCab3 | Forward |
| | | 5′-ATCAGCGTGGAGTCTAAGTC-3′ |
| | | Reverse |
| | | 5′-AAAGCCAGAGCAACCAAAC-3′ |
| | GmPIP1; | Forward |
| | 6 | 5′-AACTATGAGTTGTTCAAAGGA-3′ |
| | | Reverse |
| | | 5′-AGAAAACGGTGTAGACAAGAAC-3′ |
| | GmPIP2 | Forward |
| | | 5′-TTGGCGAGGAAGTTGTCGTTGC-3′ |
| | | Reverse |
| | | 5′-AGATCCAGTGTTCATCCCAACC-3′ |
| | GmCYP | Forward |
| | | 5′-TGTGTCGGTGGCTCTGAA-3′ |
| | | Reverse |
| | | 5′-CTCATAACAGACTCCATTCACTCT-3′ |

*ZmG2 and ZmGLK1: GOLDEN2-LIKE (GLK) transcription factors which promote photosynthetic activity by activating target genes encoding chloroplast-localized and photosynthesis-related proteins;
ZmDOF1: a transcription factor involved in the activation of photosynthetic genes in maize;
ZmPPdK: a key enzyme that utilizes the photosynthetic pathway to fix CO₂ in C4-plants;
PIP2; 1: an aquaporin belongs to the plasma membrane intrinsic protein (PIP) subfamily that facilitates membrane water permeability;
UBF7: Zea mays polyubiquitin containing 7 ubiquitin monomers, used as a reference gene;
GmWRKY58/76: Group III WRKY proteins with a C2HC zinc finger domain involved in the regulation of plant growth and developmental processes, hormone signaling, secondary metabolisms and plant stress responses;
GmNAC: a NAC domain transcriptional regulator protein, playing important roles in plant development and stress responses;
GmCab3: a light-harvesting complex (LHC) functions as a light receptor that captures and delivers excitation energy to photosystems;
GmPIP1; 6 and GmPIP 2: aquaporins which belong to the plasma membrane intrinsic protein (PIP) subfamily and facilitate membrane water permeability; and
GmCYP: a reference gene.

### 3. Results

### A. Corn

A-3.1 A composition of the present invention increases crop growth.

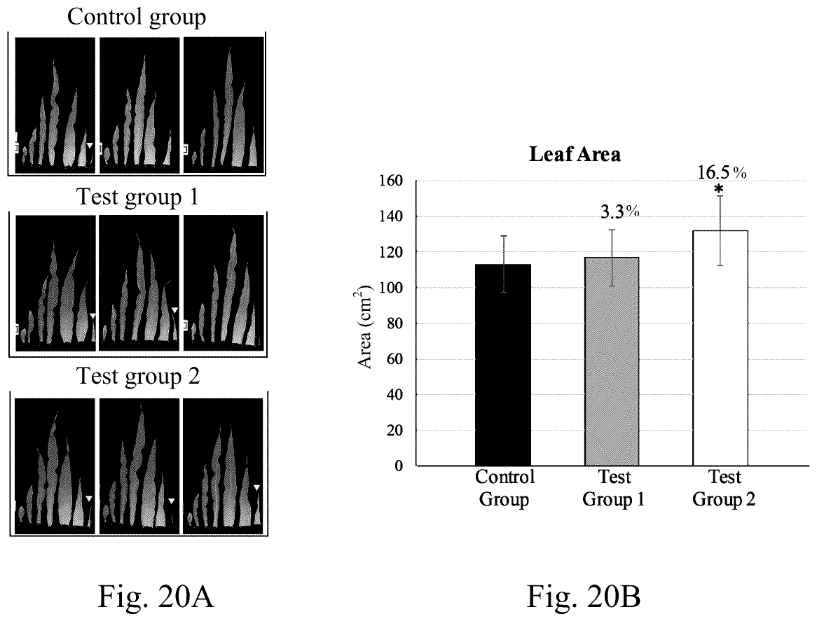

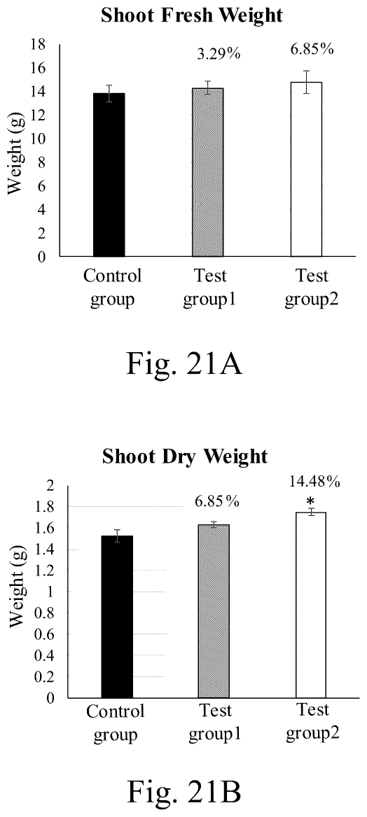

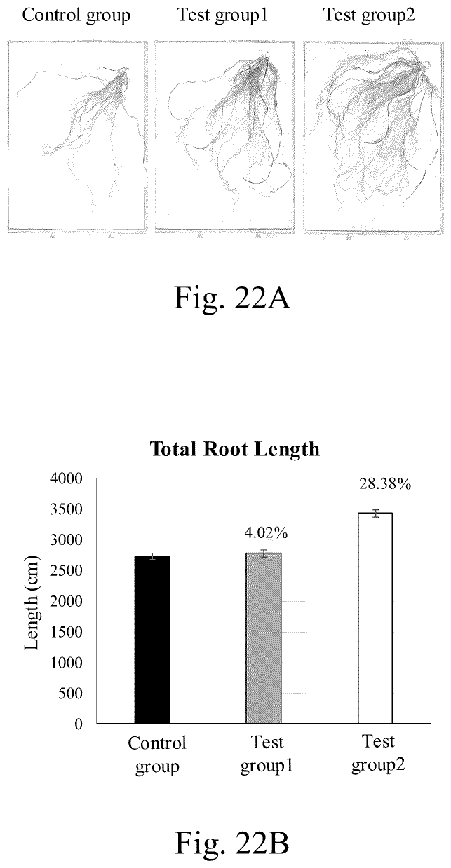

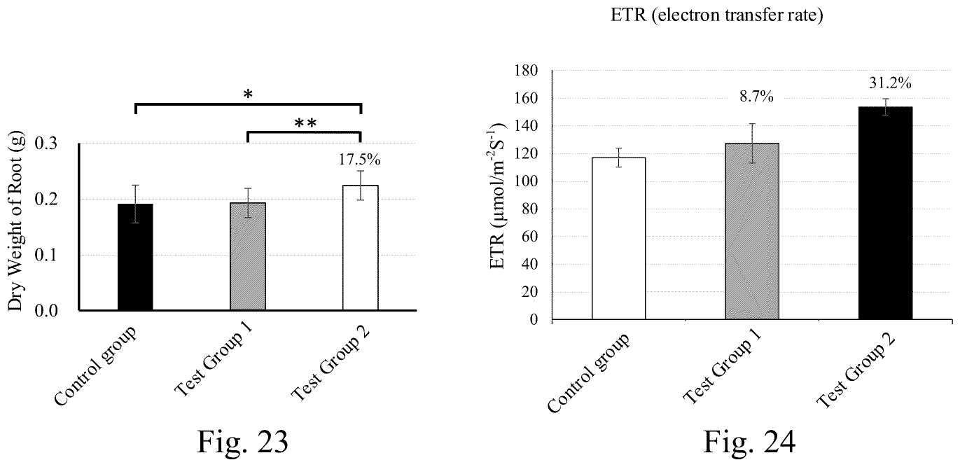

As shown in FIGS. 20-23, corn plants treated with a composition of the present invention (Test group 2) have larger leaf areas (FIGS. 20A and 20B), more shoot fresh weight (FIG. 21A), more shoot dry weight (FIG. 21B), longer root length (FIGS. 22A and 22B), and more root dry weight (FIG. 23) than corn plants treated with Control group or Test group 1.

A-3.2 A composition of the present invention improves the efficiency of plants in converting solar energy into chemical energy.

As shown in FIG. 24, a composition of the present invention (Test group 2) increases higher electron transport rates (ETR) in corn plants than Control group and Test group 1. The results indicate that a composition of the present invention promotes accumulation of energy in plants for absorbing CO₂ and synthesizing sugar.

A-3.3 A composition of the present invention improves activities of key enzymes in nitrogen assimilation in plants.

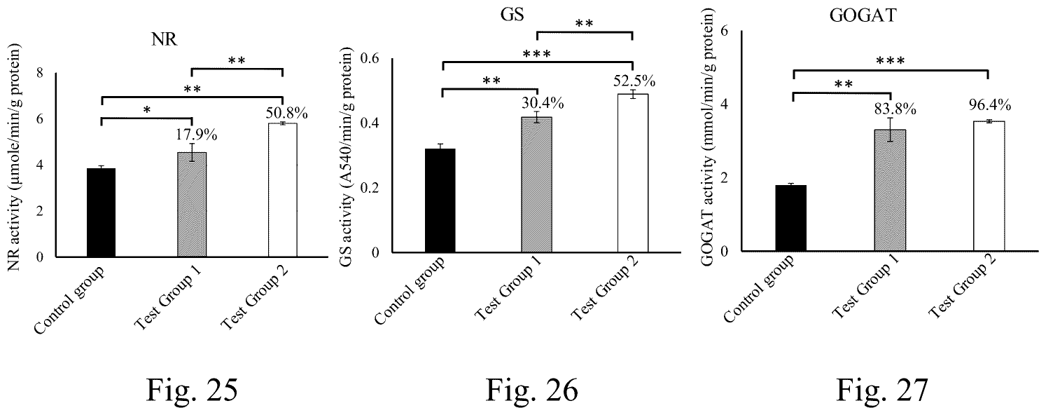

As shown in FIGS. 25-27, compared with Control group, a composition of the present invention (Test group 2) significantly increases activities of nitrate reductase (NR) (FIG. 25), glutamine synthetase (GS) (FIG. 26), and glutamate synthase (GOGAT) (FIG. 27) of corn plants by 50.8%, 52.5%, and 96.4%, respectively (p<0.01 or p<0.001). In addition, a composition of the present invention (Test group 2) increases higher activities of NR, GS, and GOGAT of corn plants.

A-3.4 A composition of the present invention induces more expression of genes related to growth, photosynthesis, and water use efficiency.

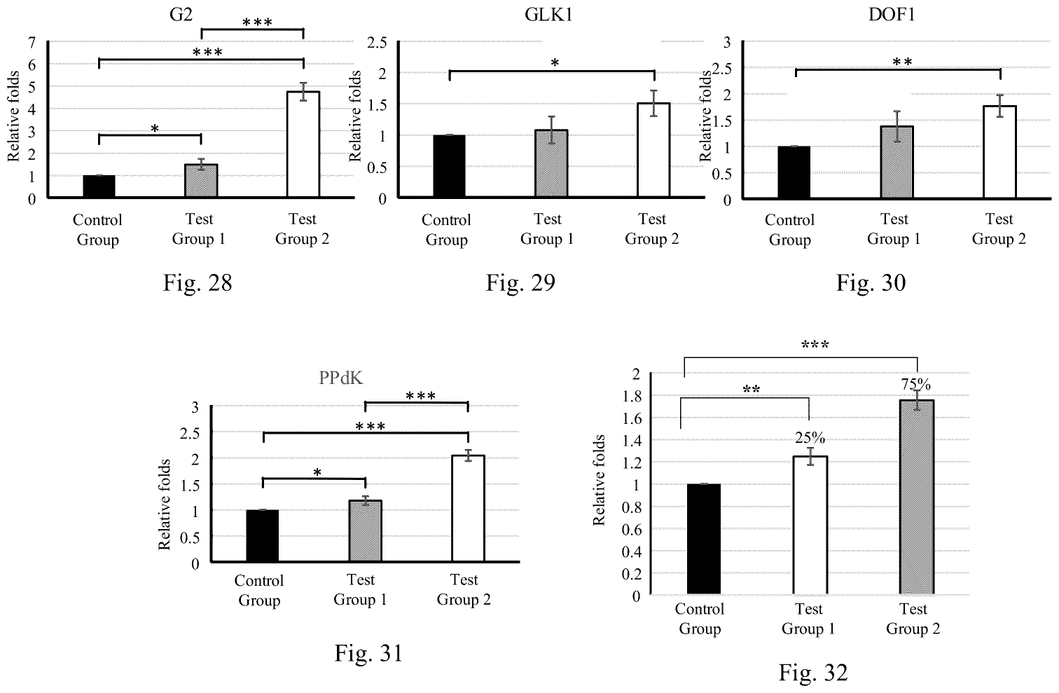

As shown in FIGS. 28-32, corn plants treated with a composition of the present invention (Test group 2) have significantly higher gene expression of ZmG2 (a gene related to increasing growth and photosynthesis; FIG. 28), ZmGLK1 (a gene related to increasing growth and photosynthesis; FIG. 29), ZmDOF1 (a gene related to increasing photosynthesis; FIG. 30), ZmPPdK (a gene related to increasing photosynthesis; FIG. 31), and ZmPIP2;1 (a gene related to improving water use efficiency; FIG. 32) than corn plants treated with Control group or Test group 1 (p<0.05 or p<0.01 or p<0.001).

### B. Soybean

B-3.1 A composition of the present invention increases crop growth.

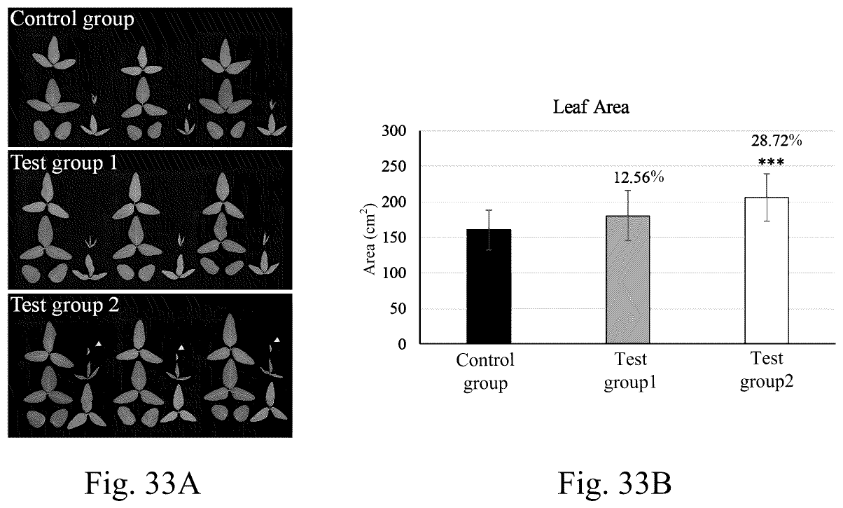

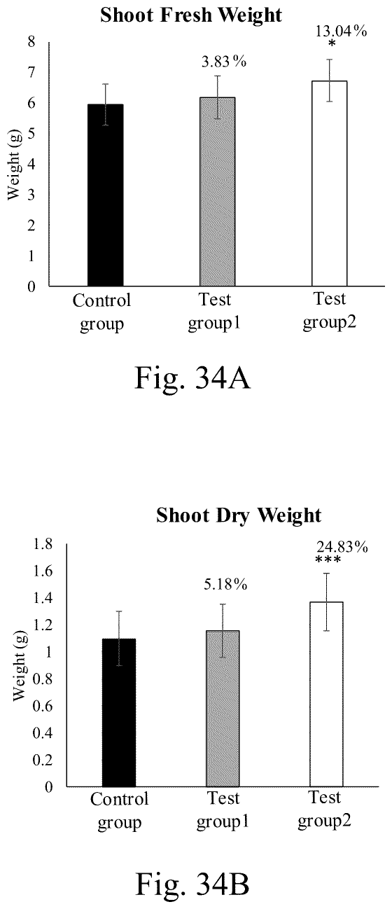

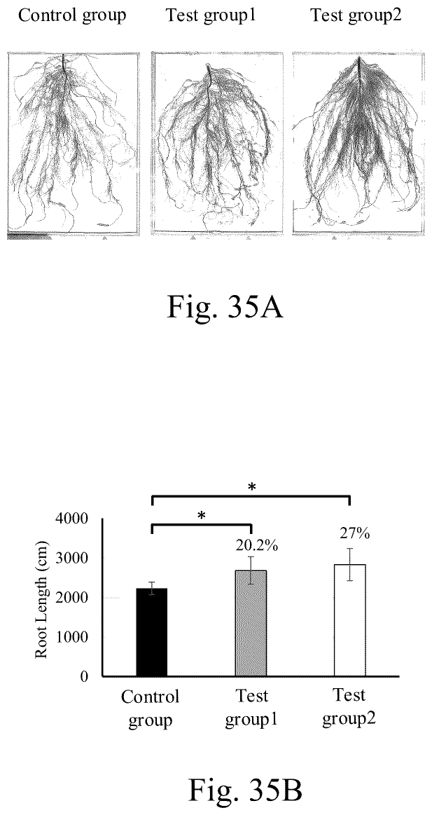

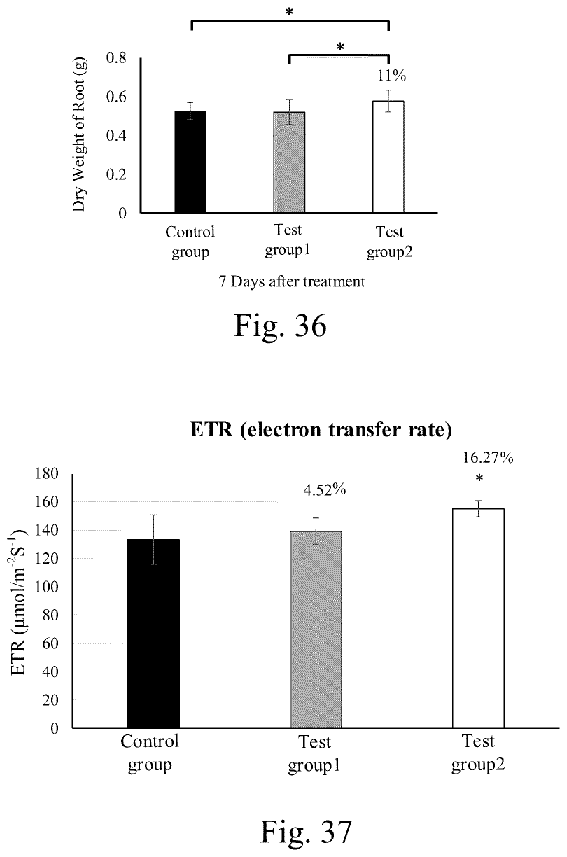

As shown in FIGS. 33-36, soybean plants treated with a composition of the present invention (Test group 2) have larger leaf areas (FIGS. 33A and 33B), more shoot fresh weight (FIG. 34A), more shoot dry weight (FIG. 34B), longer root length (FIGS. 35A and 35B), and more root dry weight (FIG. 36) than soybean plants treated with Control group or Test group 1.

B-3.2 A composition of the present invention improves the efficiency of plants in converting solar energy into chemical energy.

As shown in FIG. 37, a composition of the present invention (Test group 2) increases higher electron transport rates (ETR) in soybean plants than Control group and Test group 1. The results indicate that a composition of the present invention promotes accumulation of energy in plants for absorbing CO₂ and synthesizing sugar.

B-3.3 A composition of the present invention improves activities of key enzymes in nitrogen assimilation in plants.

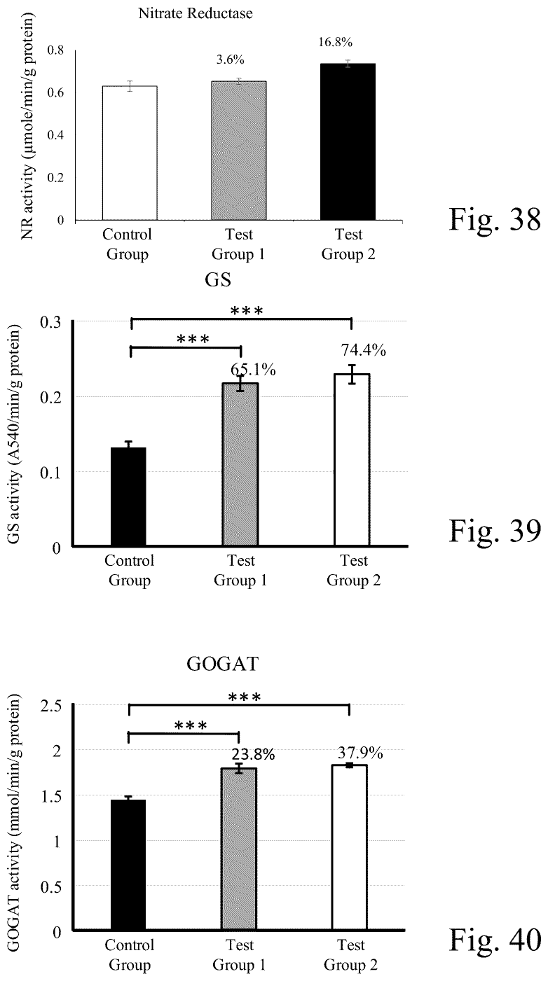

As shown in FIGS. 38-40, compared with Control group, a composition of the present invention (Test group 2) significantly increases activities of nitrate reductase (NR) (FIG. 38), glutamine synthetase (GS) (FIG. 39), and glutamate synthase (GOGAT) (FIG. 40) of soybean plants by 16.8%, 74.4%, and 37.9%, respectively (p<0.001). In addition, a composition of the present invention (Test group 2) increases higher activities of NR, GS, and GOGAT of soybean plants than Test group 1.

B-3.4 A composition of the present invention induces more expression of genes related to growth, photosynthesis, and water use efficiency.

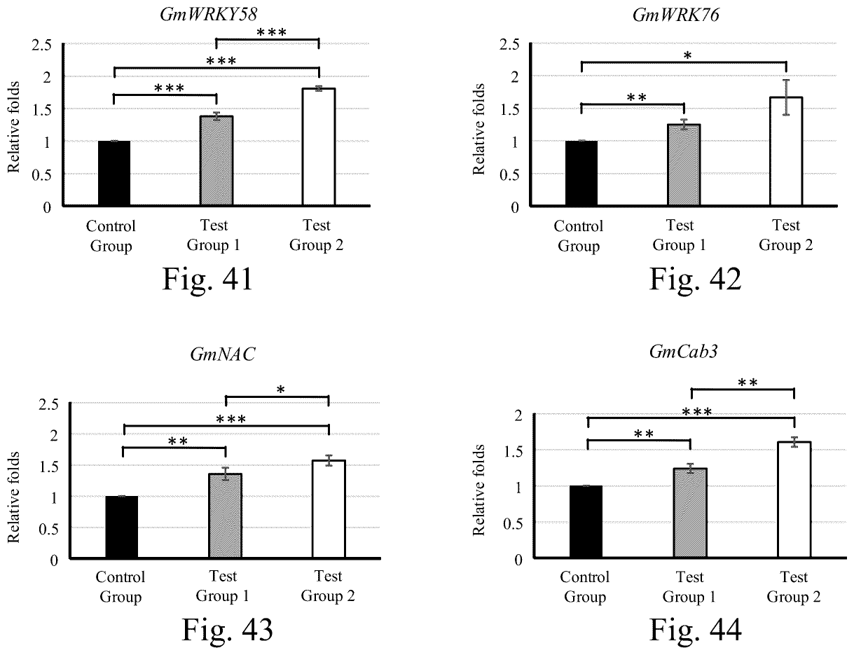

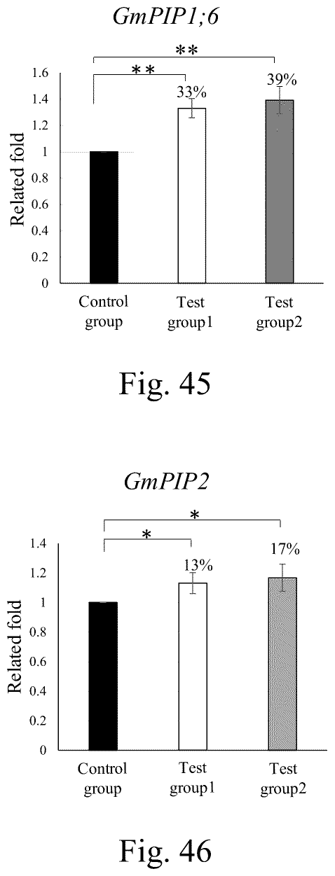

As shown in FIGS. 41-46, corn plants treated with a composition of the present invention (Test group 2) have significantly higher gene expression of GmWRKY58 (a gene related to increasing growth; FIG. 41), GmWRKY76 (a gene related to increasing growth; FIG. 42), GmNAC (a gene related to increasing growth; FIG. 43), GmCab3 (a gene related to increasing photosynthesis; FIG. 44), GmPIP1;6 (a gene related to improving water use efficiency; FIG. 45), and GmPIP2 (a gene related to improving water use efficiency; FIG. 46) than corn plants treated with Control group or Test group 1 (p<0.05 or p<0.01 or p<0.001).

To sum up, the examples demonstrate that a composition of the present invention enhances plant growth by increasing root growth, increasing photosynthesis, increasing nutrient uptake and assimilation, and increasing water management by crops.

### Example 6 RNA Seq-Analysis

### 1. Plant Growth and Treatment

Soybean seeds (Roundup Ready 2 Xtend®) were seeded in pots containing culture medium (peat soil:vermiculite=3:1) and placed in a phytotron, which was operated at 25/23° C. day/night temperature and on a 16/8 light/dark cycle. One seed was seeded in one pot. Soybean plants were applied with 0.1% (v/v) Tween® 80 (Control group) or Sample 1 (8 mg/L IBA, 1.8 mg/L Kinetin, 5 mg/L GABA, and 25 mg/L choline chloride) and 0.1% (v/v) Tween® 80 (Test group) at the stage of V1 (one set of unfolded trifoliolate leaves) once at a rate of 10 mL/12 pots using a foliar spray treatment.

### 2. Analyses

2.1 RNA-seq profiling: Three (3) replicates were performed. Six (6) days after the application of reagents, all trifoloalate leaves were collected for RNA extraction by LabPrep™ RNA plus mini kit (LabTurbo Biotech Co.). Genomic DNA was removed by TURBO DNA-free™ Kit (Thermo Fisher Scientific, Waltham, MA, USA). The RNA-seq libraries were prepared using the TruSeq RNA Library Prep Kit v2 (Illumina, Inc., San Diego, CA, USA) for sequencing on HiSeq 2500 platform (Illumina, Inc.). RNA-Seq reads were assembled into contigs, and then mapped to the Arabidopsis genome and cDNA sequences. To identify differentially expressed genes, RNA-seq reads with the fold change more than 2 were selected.

2.2 Statistics: Methods of statistics are the same as described in Example 1.

### 3. Results

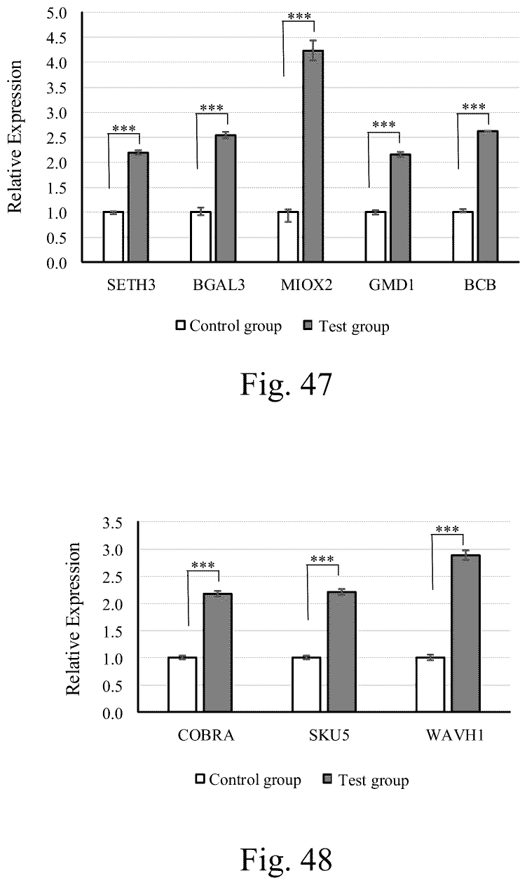

As shown in Table 13 and FIGS. 47 and 48, Sample 1 (Test group) up-regulates genes involved in lignin synthesis and cell elongation, such as SETH3, BGAL3, MIOX2, GMD1, and BCB (FIG. 47), and genes involved in root growth and elongation, such as COBRA, SKU5, and WAVH1 (FIG. 48). The results indicate that Sample 1 (a composition of the present invention) enhances plant growth by up-regulating genes related shoot and root growth.

TABLE 13
Summary of the genes whose expression is induced by
Sample 1 in Example 6

| | |
|---|---|
| Gene Name | Annotated function |

Lignin synthesis and cell elongation

| | |
|---|---|
| SETH3 | Sugar isomerase (SIS) family protein |
| BGAL3 | Beta-galactosidase 3 |
| MIOX2 | Myo-inositol oxygenase 2 |
| GMD1 | GDP-D-mannose 4,6-dehydratase 1 |
| BCB | Blue-copper-binding protein |

Root growth and elongation

| | |
|---|---|
| COBRA | COBRA-like extracellular glycosyl-phosphatidyl |
| | inositol-anchored protein family |
| SKU5 | Cupredoxin superfamily protein |
| WAVH1 | Zinc finger (C3HC4-type RING finger) family protein |

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A concentrate composition for enhancing plant growth, comprising
between about 0.8 g/L to about 80 g/L auxin;
between about 0.18 g/L to about 18 g/L cytokinin;
between about 0.5 g/L to about 50 g/L γ-Aminobutyric acid (GABA);
between about 2.5 g/L to about 250 g/L choline chloride;
0 or 0.01-1% (v/v) adjuvant; and
water.

2. The concentrate composition of claim 1, wherein the auxin is selected from indole-3-butyric acid (IBA), indole-3-acetic acid (IAA), 2-phenylacetic acid (PAA), indole-3-propionic acid (IPA), and 1-naphthaleneacetic acid (NAA).

3. The concentrate composition of claim 1, wherein the cytokinin is selected from N6-furfuryladenine (kinetin), 6-Benzylaminopurine (BA), zeatin (ZT), N6-(2-isopentenyl) adenine (2ip), diphenylurea (DPU), and thidiazuron (TDZ).

4. The concentrate composition of claim 1, wherein the concentrate composition enhances plant growth by at least one of the methods selected from increasing shoot growth, increasing root growth, increasing photosynthesis in plants, increasing nutrient uptake and assimilation, increasing water management by plants, and reducing herbicide mediated phototoxicity in plants.

5. A ready to use composition for enhancing plant growth, comprising essentially of
between about 0.8 mg/L to about 80 mg/L auxin;
between about 0.18 mg/L to about 18 mg/L cytokinin;
between about 0.5 mg/L to about 50 mg/L γ-Aminobutyric acid (GABA);
between about 2.5 mg/L to about 250 mg/L choline chloride;
0% or 0.01-1% (v/v) adjuvant; and
water.

6. The ready to use composition of claim 5, wherein the auxin is selected from indole-3-butyric acid (IBA), indole-3-acetic acid (IAA), 2-phenylacetic acid (PAA), indole-3-propionic acid (IPA), and 1-naphthaleneacetic acid (NAA).

7. The ready to use composition of claim 5, wherein the cytokinin is selected from N6-furfuryladenine (kinetin), 6-Benzylaminopurine (BA), zeatin (ZT), N6-(2-isopentenyl) adenine (2ip), diphenylurea (DPU), and thidiazuron (TDZ).

8. The ready to use composition of claim 5, wherein the adjuvant is a surfactant.

9. The ready to use composition of claim 8, wherein the adjuvant is a drift control agent.

10. The ready to use composition of claim 5, wherein the ready to use composition enhances plant growth by at least one of the methods selected from increasing shoot growth, increasing root growth, increasing photosynthesis in plants, increasing nutrient uptake and assimilation, increasing water management by plants, and reducing herbicide mediated phototoxicity in plants.

11. The ready to use composition of claim 5, wherein the ready to use composition consists of
between about 0.8 mg/L to about 80 mg/L auxin;
between about 0.18 mg/L to about 18 mg/L cytokinin;
between about 0.5 mg/L to about 50 mg/L γ-Aminobutyric acid (GABA);
between about 2.5 mg/L to about 250 mg/L choline chloride;
0% or 0.01-1% (v/v) adjuvant; and
water.

12. A method for enhancing plant growth, comprising a step of applying a use solution composition to a plant, and the use solution composition consisting essentially of
between about 0.8 mg/L to about 80 mg/L auxin;
between about 0.18 mg/L to about 18 mg/L cytokinin;
between about 0.5 mg/L to about 50 mg/L γ-Aminobutyric acid (GABA);
between about 2.5 mg/L to about 250 mg/L choline chloride; and
water.

13. The method of claim 12, wherein the auxin is selected from indole-3-butyric acid (IBA), indole-3-acetic acid (IAA), 2-phenylacetic acid (PAA), indole-3-propionic acid (IPA), and 1-naphthaleneacetic acid (NAA).

14. The method of claim 12, wherein the cytokinin is selected from N6-furfuryladenine (kinetin), 6-Benzylaminopurine (BA), zeatin (ZT), N6-(2-isopentenyl) adenine (2ip), diphenylurea (DPU), and thidiazuron (TDZ).

15. The method of claim 12, further comprising a step of mixing the use solution composition with an adjuvant before the step of applying the use solution composition to the plant.

16. The method of claim 12, wherein the use solution composition is applied to foliage of the plant.

17. The method of claim 12, wherein the use solution composition is applied to roots of the plant.

18. The method of claim 12, wherein the use solution composition enhances plant growth by at least one of the methods selected from increasing shoot growth, increasing root growth, increasing photosynthesis in plants, increasing nutrient uptake and assimilation, increasing water management by plants, and reducing herbicide mediated phototoxicity in plants.
